(19) United States
(12) Patent Application Publication
(10) Pub. No.: US 2026/0077548 A1
(43) Pub. Date: Mar. 19, 2026

(54) SYSTEM AND METHOD FOR ELONGATE PIPELINE MANUFACTURING IN-SITU

(71) Applicant: ADAPTIVE PIPELINE TECHNOLOGIES, INC., Golden, CO (US)

(72) Inventor: James E. Schmitz, Golden, CO (US)

(73) Assignee: ADAPTIVE PIPELINE TECHNOLOGIES, INC., Golden, CO (US)

(21) Appl. No.: 19/110,036

(22) PCT Filed: Sep. 7, 2023
(86) PCT No.: PCT/US23/73673

§ 371 Date: Mar. 7, 2025

Related U.S. Application Data
(60) Provisional application No. 63/404,935, filed on Sep. 8, 2022.

(51) Int. Cl. B29C 48/09; B29C 48/025; B29C 48/265; B29C 48/92; B29L 23/00

(52) U.S. Cl. CPC B29C 48/09; B29C 48/025; B29C 48/265; B29C 48/92; B29L 2023/22

(57) ABSTRACT

One embodiment is directed to a mobile pipeline extrusion system, comprising: a first mobile vehicle having a first electromechanical drive system and a first active suspension configured to stabilize the first mobile vehicle relative to terrain over which it may be navigated; a second mobile vehicle removably coupleable to the first mobile vehicle and having a second electromechanical drive system and a second active suspension configured to stabilize the second mobile vehicle relative to terrain over which it may be navigated; a computing system operably coupled to the first and second mobile vehicles and configured to operate the first and second electromechanical drive systems and first and second active suspensions such that the first and second mobile vehicles may move together in an end-to-end coupling configuration as a unified operational platform; and a polymeric pipeline extrusion system operatively coupled to the unified operational platform and configured to receive input materials, heat the input materials, process the input materials through an extrusion die, and produce an output pipeline.

### FIELD OF THE INVENTION

The present invention relates generally to systems and methods for the creation and enhancement of pipeline systems for the transportation of materials such as water, wastewater, gasses, slurries, and/or other petroleum-related fluids, and more specifically to mobile and modular configurations designed for creating long lengths of pipeline at or adjacent to final installation locations in various environments.

### BACKGROUND

Pipelines of various configurations remain important for the transportation and routing of key resources such as water, wastewater, gasses, slurries, and/or other petroleum-related fluids. It has been estimated that there are over 2 million miles of pipelines installed in 120 countries of the world. Referring to FIG. 1, pipeline installation may involve creation of a trench to install at least a portion of a pipeline underground. FIG. 1 shows a trenching machine (2) featuring a trench cutting tool (4) which may be utilized to remove material from targeted terrain, thereby creating a trench (10) and leaving two trench abutments (6, 8) on either side of the trench (10). Referring to FIG. 2A, a trenching machine (2) is shown removing material with a cutting tool (4) to create a long trench (10) defined between two trench abutments (6, 8). FIG. 2B illustrates that a completed trench may be defined by a trench base (12), a first trench wall (14), a second trench wall (16), and adjacent trench abutments (6, 8), which may be at least partially utilized to hold removed material, or “spoils”, as part of the process in creating the trench. For example, referring to FIG. 2B, some of the trenching spoils (18, 20) have been left on each trench abutment (6, 8) in the depicted scenario.

Referring to FIGS. 3A and 3B, one of the challenges in creating many modern pipeline systems is that pipeline segments, often manufactured in a factory remote from the pipeline installation site, may be limited in length due to storage and/or transportation challenges. In other words, many pipeline manufacturers have found it most economical to manufacturing pipeline segments in lengths that may be transported conveniently in standard-length shipping containers, rail cars, and/or trucks. FIG. 3A illustrates a typical conventional scenario wherein pipeline segments (24) are stacked at a job site at a location near a pipeline installation; the segments may be moved by truck (22) as shown. FIG. 3B illustrates a segment handling machine, which may be based upon a bulldozer or tractor type of base and configured to grasp, manipulate or move, and release segments (24) of pipeline materials to move them to and from trucks (22), stack them, etc.

Referring to FIGS. 4A-4D, at an installation site, segments (24) may be lifted into place, such as via a hoist system (28), which may be at least partially powered by an intercoupled machine such as a bulldozer (30). As shown in FIGS. 4B-4D, various arms of hoisting systems (28) may be utilized to lift multiple coupled segments (24) of pipeline together into an installation position and/or orientation, such as within a trench (10). One of the critical issues pertaining to manufacturing, construction, operation, and/or maintenance of a pipeline is in preventing leaks, and leaks often are correlated with or positioned at or adjacent to junctions or coupling between adjacent segments (24). Particularly with pipelines comprised of materials with some ability to flex rather than fracture, such as the pipeline shown being lowered into a trench (10) in FIG. 4D, it would be desirable to decrease the number of junctions between adjacent segments. In other words, it would be valuable to have less junctions or couplings, and more elongate segments of installed pipeline without such junctions or couplings. Some attempts have been made to address the challenge of producing pipelines with less segments or couplings, while also providing installation economics which can make sense in view of current cost structures which generally have driven pipeline manufacturers to utilize the aforementioned configuration, wherein pipeline segments are manufactured off-site, delivered, and joined in-situ. Referring to FIG. 5, assemblies of pipeline segment manufacturing components (32, 34, 36, 38, 40) have been de-coupled from one another, shipped in a series of shipping containers, and re-assembled in the field to essentially create an on-site pipe manufacturing plant which can be shipped to sites all over the world utilizing container ships and trucks. Such a configuration is somewhat analogous to the paradigm utilized by some urban construction companies which, rather than transporting truck after truck of wet concrete from a remote concrete plant, build a small concrete plant on site at a major job, and then transport wet concrete only the small distance from the on-site plant to the various installation locations on the site.

With a configuration wherein a modular pipeline segment manufacturing plant is re-assembled on-site through coupling of a plurality of shipping containers together, there remain limitations as regards length of segments which practically can be manufactured, handled, and positioned/oriented into a trench of other installation configuration. In other words, while such a modular configuration may be utilized to create pipeline segment lengths that are longer than a typical shipping container, there still may be complications in terms of handling, moving, positioning, and orienting completed segments relative to a trench or other installation which limit the practical length of such segments. Given the lengths of many pipeline installation projects around the world, there is a need for a pipeline manufacturing system which can create relatively long lengths of pipeline adjacent to installation destinations in a manner wherein final manipulation, positioning, and orientation is practical and efficient.

### BRIEF DESCRIPTION OF THE DRAWINGS

FIG. 1 illustrates a trenching machine.

FIGS. 2A and 2B illustrate aspects of a trenching operation for a pipeline installation.

FIGS. 3A and 3B illustrate stacks of conventional pipeline segments to be coupled in a pipeline installation.

FIGS. 4A-4D illustrate aspects of conventional pipeline installation using segmented pipeline modules.

FIG. 5 illustrates aspects of a modular pipeline system configured to be assembled at a given location in the field.

FIGS. 6A-6E illustrate aspects of active drive and active suspension systems for a mobile pipeline extrusion system.

FIGS. 7A-7J illustrate aspects of operational aspects pertaining to a mobile pipeline extrusion system.

FIGS. 8A-8J illustrate aspects of operational aspects pertaining to a mobile pipeline extrusion system.

FIGS. 9A and 9B illustrate aspects of processes pertaining to a mobile pipeline extrusion system.

FIGS. 10A-10G illustrate aspects of operational aspects pertaining to a mobile pipeline extrusion system.

FIGS. 11A-11D illustrate aspects of operational aspects pertaining to a mobile pipeline extrusion system.

FIGS. 12A and 12B illustrate aspects of processes pertaining to a mobile pipeline extrusion system.

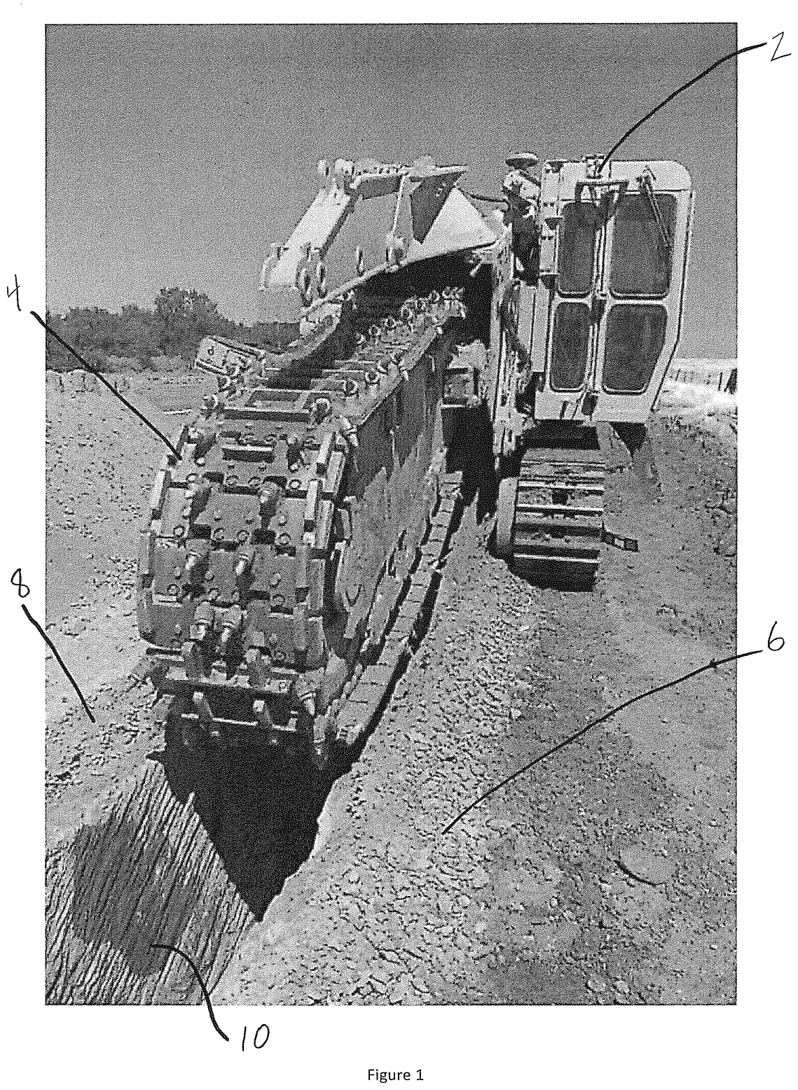

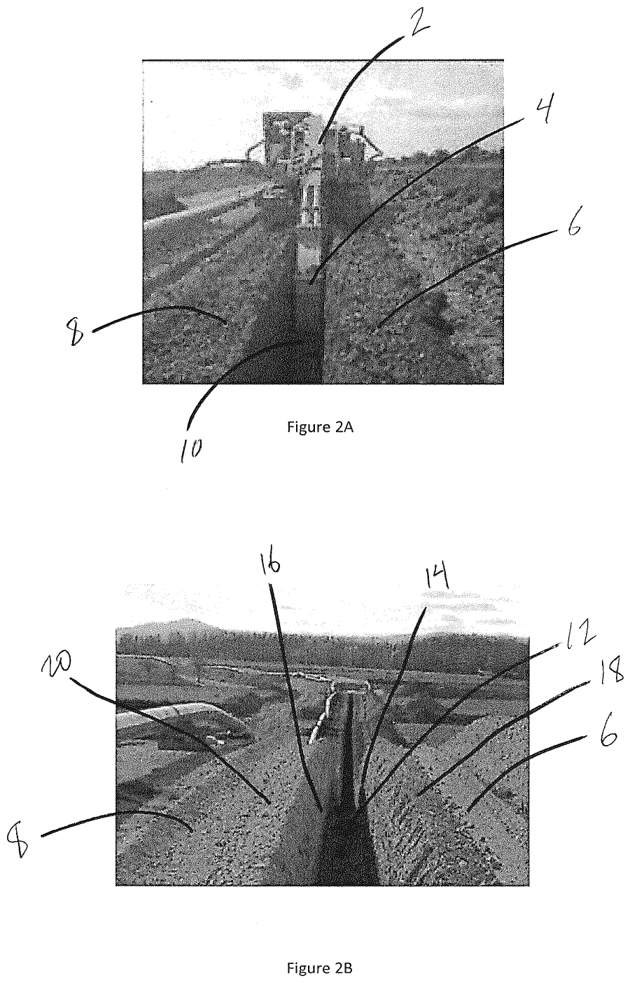

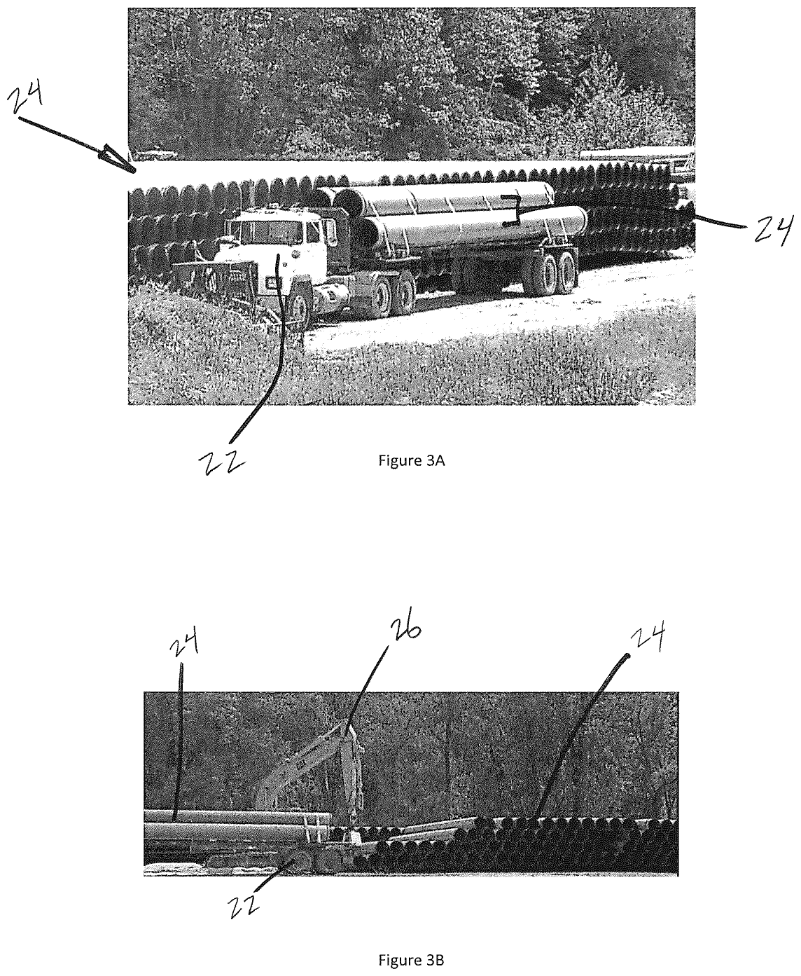

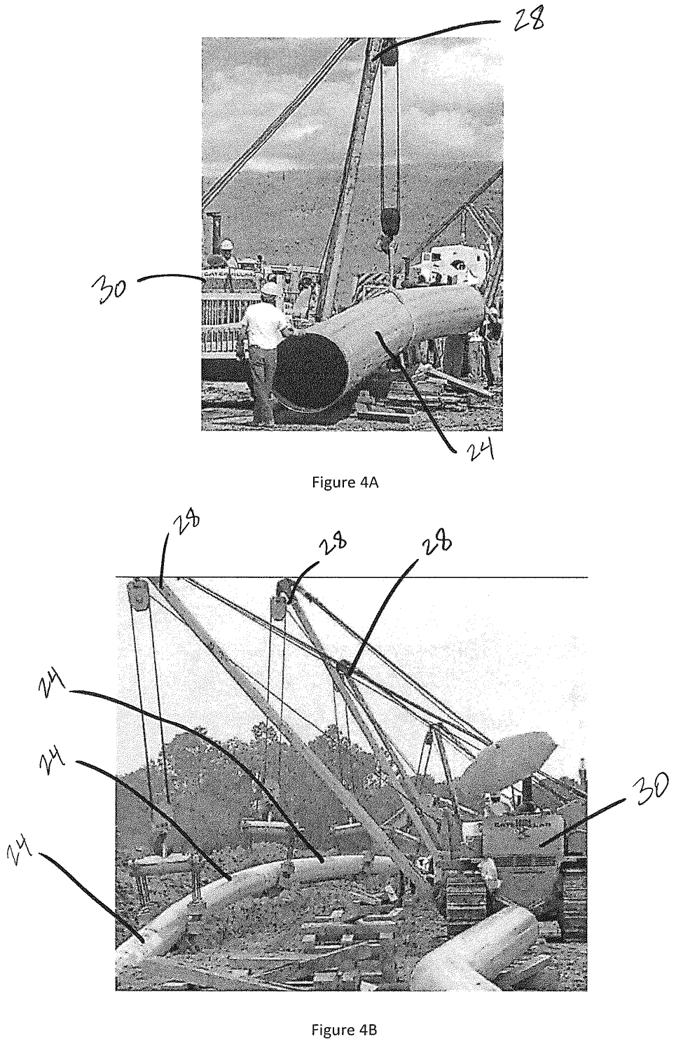

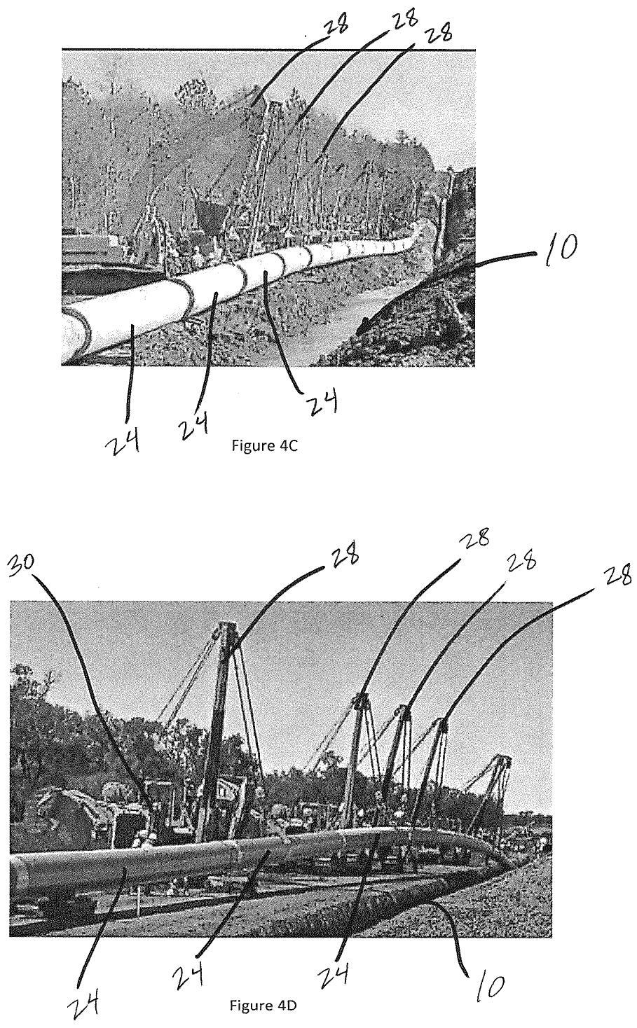

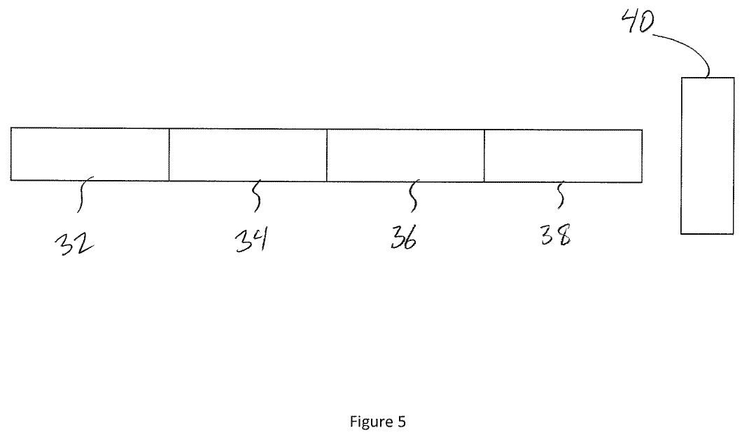

### SUMMARY

One embodiment is directed to a mobile pipeline extrusion system, comprising: a first mobile vehicle having a first electromechanical drive system and a first active suspension configured to stabilize the first mobile vehicle relative to terrain over which it may be navigated; a second mobile vehicle removably coupleable to the first mobile vehicle and having a second electromechanical drive system and a second active suspension configured to stabilize the second mobile vehicle relative to terrain over which it may be navigated; a computing system operably coupled to the first and second mobile vehicles and configured to operate the first and second electromechanical drive systems and first and second active suspensions such that the first and second mobile vehicles may move together in an end-to-end coupling configuration as a unified operational platform; and a polymeric pipeline extrusion system operatively coupled to the unified operational platform and configured to receive input materials, heat the input materials, process the input materials through an extrusion die, and produce an output pipeline. The first electromechanical drive system may comprise a plurality of electric motors. The first electromechanical drive system may comprise three or more wheels and is configured to provide two or more degrees of freedom of controllable motion at each wheel. The first electromechanical drive system may be configured to provide controlled active wheel drive as well as active wheel steer for each of the two or more degrees of freedom of controllable motion at each wheel. The first electromechanical drive system degrees of freedom of controllable motion may be configured to cause the first mobile vehicle to be electromechanically holonomic. The first mobile vehicle may comprise four wheels. The first mobile vehicle may comprise six wheels. The first active suspension may comprise an electric motor operatively coupled to a wheel of the first mobile vehicle. The electric motor may be configured to controllably raise or lower the wheel relative to the first mobile vehicle. The system further may comprise one or more sensors configured to characterize at least one aspect of the terrain adjacent the wheel, wherein the electric motor is configured to controllably raise or lower the wheel relative to the first mobile vehicle responsive to the at least one aspect of the terrain adjacent the wheel. The one or more sensors may be configured to characterize the elevation of the terrain adjacent the wheel. The one or more sensors may comprise an image capture device. The one or more sensors may comprise a LIDAR sensor. The system further may comprise a computer operatively coupled to the first mobile vehicle and configured to operate the first electromechanical drive and first active suspension dynamic to the terrain over which the first mobile vehicle is navigated, and also dynamic to operation of the polymeric pipeline extrusion system. The computer may be configured to operate utilizing a convolutional neural network configured to modulate operation of the first mobile vehicle dynamic to detected inputs as well as training data from previous runtime events. The polymeric pipeline extrusion system may output the output pipeline at an output velocity, and the computer may be configured to operate the first electromechanical drive and first active suspension to have a first mobile vehicle forward drive velocity that approximately matches the output velocity. The first and second mobile vehicles may be configured to be removably coupleable using a latch mechanism. The latch mechanism may be manually operable. The latch mechanism may be electromechanically operable. The latch mechanism may comprise one or more removable locking pins. The latch mechanism may comprise a plurality of complementary mechanical engagement features. The first and second mobile vehicles may be configured to be removably coupleable using an electromagnet. The input materials may be selected from the group consisting of: liquid polymeric resin, solid polymeric resin pellets, and solid polymeric resin powder. The system further may comprise a power generation system coupled to the unified operational platform. The system further may comprise a thermal management output ramp coupled to the unified operational platform. The system further may comprise an input materials supply vehicle configured to provision the input materials to the polymeric pipeline extrusion system during operation. The system further may comprise an input hopper configured to contain the input materials as they are fed into the polymeric pipeline extrusion system.

Another embodiment is directed to a mobile pipeline extrusion method, comprising: providing a first mobile vehicle having a first electromechanical drive system and a first active suspension configured to stabilize the first mobile vehicle relative to terrain over which it may be navigated, a second mobile vehicle removably coupleable to the first mobile vehicle and having a second electromechanical drive system and a second active suspension configured to stabilize the second mobile vehicle relative to terrain over which it may be navigated, a computing system operably coupled to the first and second mobile vehicles and configured to operate the first and second electromechanical drive systems and first and second active suspensions such that the first and second mobile vehicles may move together in an end-to-end coupling configuration as a unified operational platform, and a polymeric pipeline extrusion system operatively coupled to the unified operational platform and configured to receive input materials, heat the input materials, process the input materials through an extrusion die, and produce an output pipeline; and navigating the unified operational platform forward while outputting the output pipeline at a selectable output length. The first electromechanical drive system may comprise a plurality of electric motors. The first electromechanical drive system may comprise three or more wheels and is configured to provide two or more degrees of freedom of controllable motion at each wheel. The first electromechanical drive system may be configured to provide controlled active wheel drive as well as active wheel steer for each of the two or more degrees of freedom of controllable motion at each wheel. The first electromechanical drive system degrees of freedom of controllable motion may be configured to cause the first mobile vehicle to be electromechanically holonomic. The first mobile vehicle may comprise four wheels. The first mobile vehicle may comprise six wheels. The first active suspension may comprise an electric motor operatively coupled to a wheel of the first mobile vehicle. The electric motor may be configured to controllably raise or lower the wheel relative to the first mobile vehicle. The method further may comprise providing one or more sensors configured to characterize at least one aspect of the terrain adjacent the wheel, wherein the electric motor is configured to controllably raise or lower the wheel relative to the first mobile vehicle responsive to the at least one aspect of the terrain adjacent the wheel. The one or more sensors may be configured to characterize the elevation of the terrain adjacent the wheel. The one or more sensors may comprise an image capture device. The one or more sensors may comprise a LIDAR sensor. The method further may comprise providing a computer operatively coupled to the first mobile vehicle and configured to operate the first electromechanical drive and first active suspension dynamic to the terrain over which the first mobile vehicle is navigated, and also dynamic to operation of the polymeric pipeline extrusion system. The computer may be configured to operate utilizing a convolutional neural network configured to modulate operation of the first mobile vehicle dynamic to detected inputs as well as training data from previous runtime events. The polymeric pipeline extrusion system may output the output pipeline at an output velocity, and the computer may be configured to operate the first electromechanical drive and first active suspension to have a first mobile vehicle forward drive velocity that approximately matches the output velocity. The first and second mobile vehicles may be configured to be removably coupleable using a latch mechanism. The latch mechanism may be manually operable. The latch mechanism may be electromechanically operable. The latch mechanism may comprise one or more removable locking pins. The latch mechanism may comprise a plurality of complementary mechanical engagement features. The first and second mobile vehicles may be configured to be removably coupleable using an electromagnet. The input materials may be selected from the group consisting of: liquid polymeric resin, solid polymeric resin pellets, and solid polymeric resin powder. The method further may comprise providing a power generation system coupled to the unified operational platform. The method further may comprise providing a thermal management output ramp coupled to the unified operational platform. The method further may comprise providing an input materials supply vehicle configured to provision the input materials to the polymeric pipeline extrusion system during operation. The method further may comprise providing an input hopper configured to contain the input materials as they are fed into the polymeric pipeline extrusion system.

### DETAILED DESCRIPTION

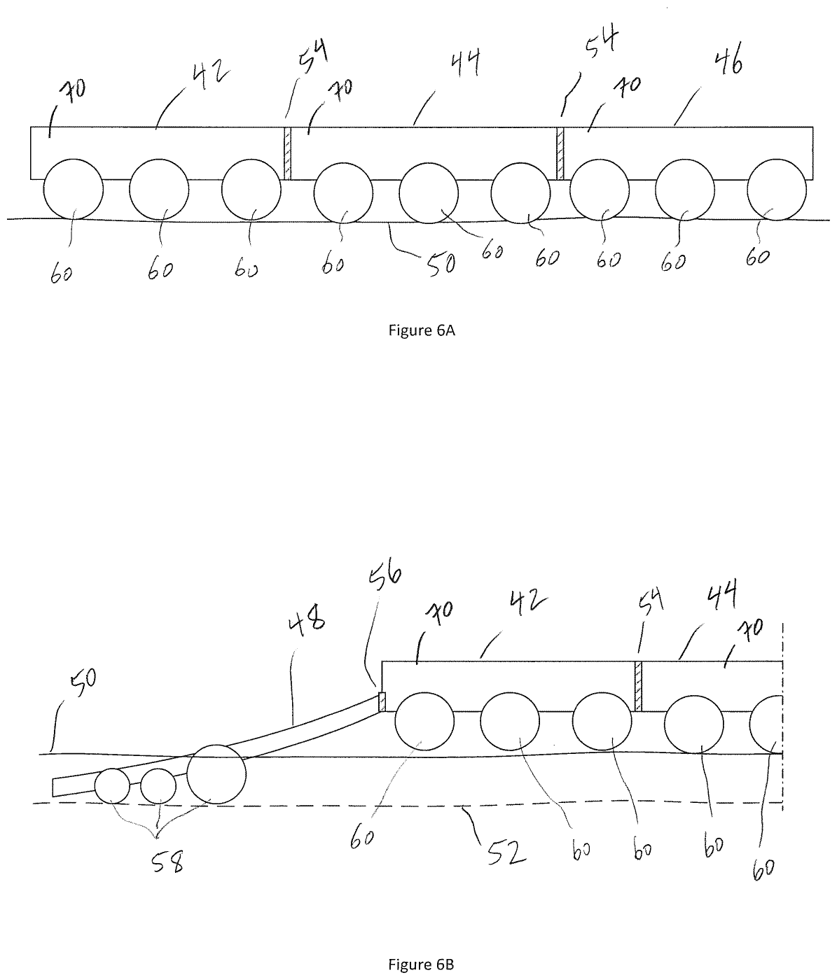

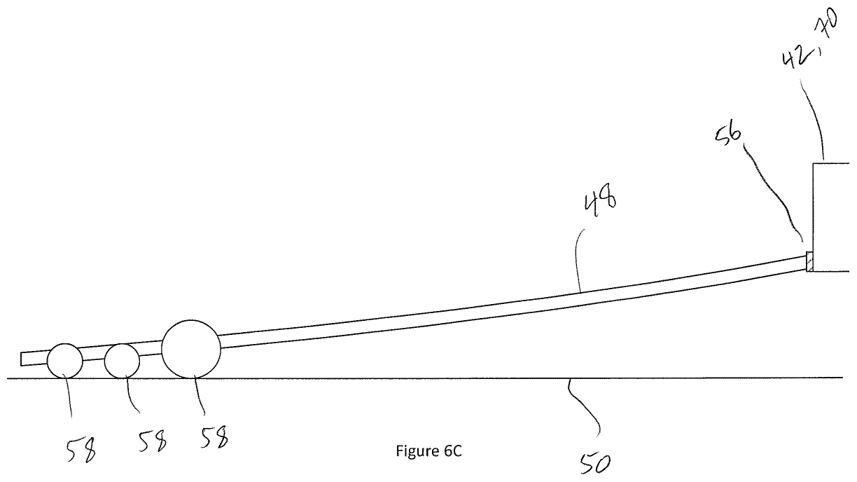

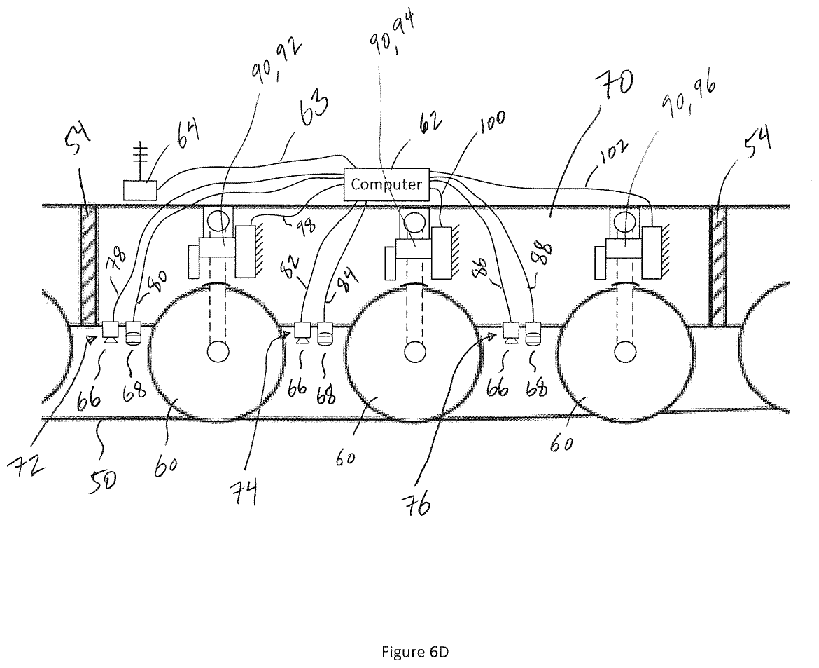

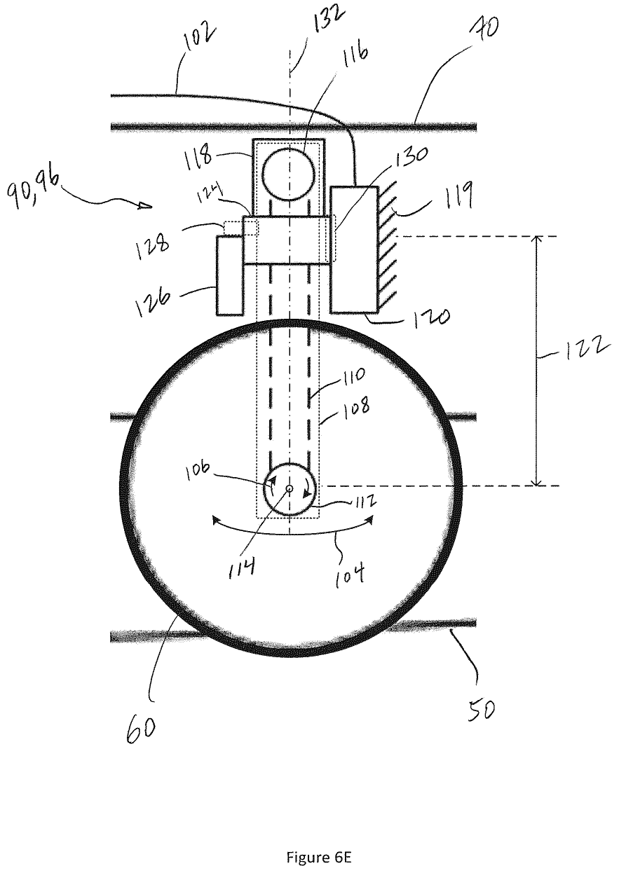

Referring to FIG. 6A, an assembly of three (42, 44, 46) pipeline manufacturing vehicles (70) are illustrated removably coupled (54) together in an end-to-end formation. In the depicted configuration, each of the illustrated vehicles (42, 44, 46) features a plurality (such as six, as shown) actively driven wheels (60) to assist with traction, terrain handling, and vehicle orientation capabilities as each vehicle navigates along a surface such as a dirt/earth ground (50) area adjacent a pipeline installation location. In operation as coupled, it is preferred that the vehicles operate together as a unified operating platform; in other words, it is desirable to have a relatively large and stable platform upon which an extrusion operation may be conducted without significant relative motion between portions of the assembly (i.e., without substantial motion between intercoupled vehicles). Thus in operation, an active suspension and multi-degree-of-freedom drive configuration may be utilized, along with harmonized computerized control of each component, such that the intercoupled platform may move together, rotate or turn together (such as in a holonomic manner, as noted below), and handle terrain in a unified manner without significant stress or motion between joined components. Referring to FIG. 6B, the assembly may feature a trailer (48) module removably coupled (56) to a vehicle (42, 70) and having a plurality of wheels, such as passive or actively-driven or steered wheels (58) configured to assist with providing an elongate ramp which may be configured to deliver manufactured product or other items to the ground (50) level, as shown in the close-up view of FIG. 6C, or to the base (52) of a trench should the trailer module (48) be positioned within the trench as shown in FIG. 6B.

Referring to FIG. 6D, in one embodiment, a pipeline manufacturing vehicle (70) may be configured to navigate holonomically or substantially-holonomically such that each of the drive wheels of the plurality is capable of driven rotation about a conventional wheel/tire roll axis, and also controllable adjustment up and down relative to the ground as well as steering type rotation left or right. In other words, referring to the close-up view of FIG. 6E, one (96) of the plurality of drive assemblies (90) of a vehicle (70) such as that illustrated in FIG. 6D is shown. A coupling member (118) may be fixedly coupled to the vehicle (70) frame and movably coupled (130) to a motorized mounting member, such as with a lead screw or ball screw configuration mounted to a rotational axis of a motor, to provide for electromechanical raising or lowering (122) of the mounting member (124) relative to the vehicle (70) frame (which provides a raising or lowering degree of freedom for the associated wheel/tire 60). Referring to FIG. 6E, a motor housing (118) may be fixedly coupled to the mounting member (124) and configured to rotate a pulley or drive wheel (116) to drive an intercoupled belt (110) around an intercoupled driven hub (112) to drive (106) the associated wheel/tire (60) about a hub axis (114). The wheel may be rotated (104) about depicted axis 132 for an individual wheel “steerability” degree-of-freedom using a motor (126) movably coupled (128), such as via a geared interface, to rotate an elongate housing (108) along with the motor housing (118), drive belt (110), hub (112), and wheel/tire (60), relative to the mounting member (124), coupling member (120) and vehicle (70) frame. Thus such a configuration may be electromechanically operated, such as via an intercoupled computing system (62) (such as by wired connection 102, and/or via wireless connection to a wireless transceiver 64 which may be operatively coupled to the computing system 62), such that each wheel may be affirmatively driven via rotation of the hub (112) about the hub axis (114), affirmative raising or lowering (122) relative to the frame of the vehicle (70), as well as steering rotation (104) about the depicted axis 132. Referring back to FIG. 6D, each wheel (60) may be associated with its own (92, 94, 96) independent drive assembly (90), each of which may be operatively coupled to the computing system (62) (such as via wired lead 98, 100, 102; or wireless connectivity to an intercoupled transceiver 64 which may be operatively coupled 63 to the computing system 62, such as via wired or wireless connectivity).

Also shown operatively coupled to the computing system (62) (such as via wired 78/80; 82/84; 86/88 connectivity; or wireless connectivity to the transceiver 64 which may be operatively coupled 63 to the computing system 62, such as via wired or wireless connectivity) are groups of sensors (66, 68; first, second, and third sensor groups are illustrated as 72, 74, 76; in other words, the depicted configuration features one sensor group configured to capture data pertaining to the terrain adjacent each wheel, so that the wheels may be independently controlled to assist in operating the vehicle) selected and configured to assist in monitoring and analyzing the state and position of the terrain surface (50) and associated wheels/tires (60) relative to the vehicle (70) frame. For example, in various embodiments, each of the groups of sensors may comprise one or more digital image sensors (66) for red/green/blue color configurations, black/white, infrared, and/or depth/time-of-flight (for example, such as the image capture devices sold under the tradename RealSense (RTM) by Intel Corporation), as well as one or more compact LIDAR sensors (68), such as those available from manufacturers such as Velodyne LIDAR, Inc., Luminar Technologies, Inc., Ouster, Inc., Aeve Technologies, Inc., AEye, Inc., or Innoviz Technologies, Inc. The depicted embodiment features one set (66, 68) of sensors for each vehicle (70) wheel (60) to assist with navigational information pertaining to the terrain being followed and the operation of each driven wheel (60); thus a total of 6 or more sets (66, 68) of sensors for a 6-wheeled vehicle (70) as shown in FIG. 6D. Such a configuration, with the pertinent sensors operatively coupled to the computing system, allows for precision and coordinated holonomic or semi-holonomic movement of the vehicle (70) relative to the ground or contact surface (50) below, while also providing for maintenance of vehicle leveling, sloping, or other preferred orientation relative to the terrain, which may be key for certain pipeline manufacturing issues as discussed further below.

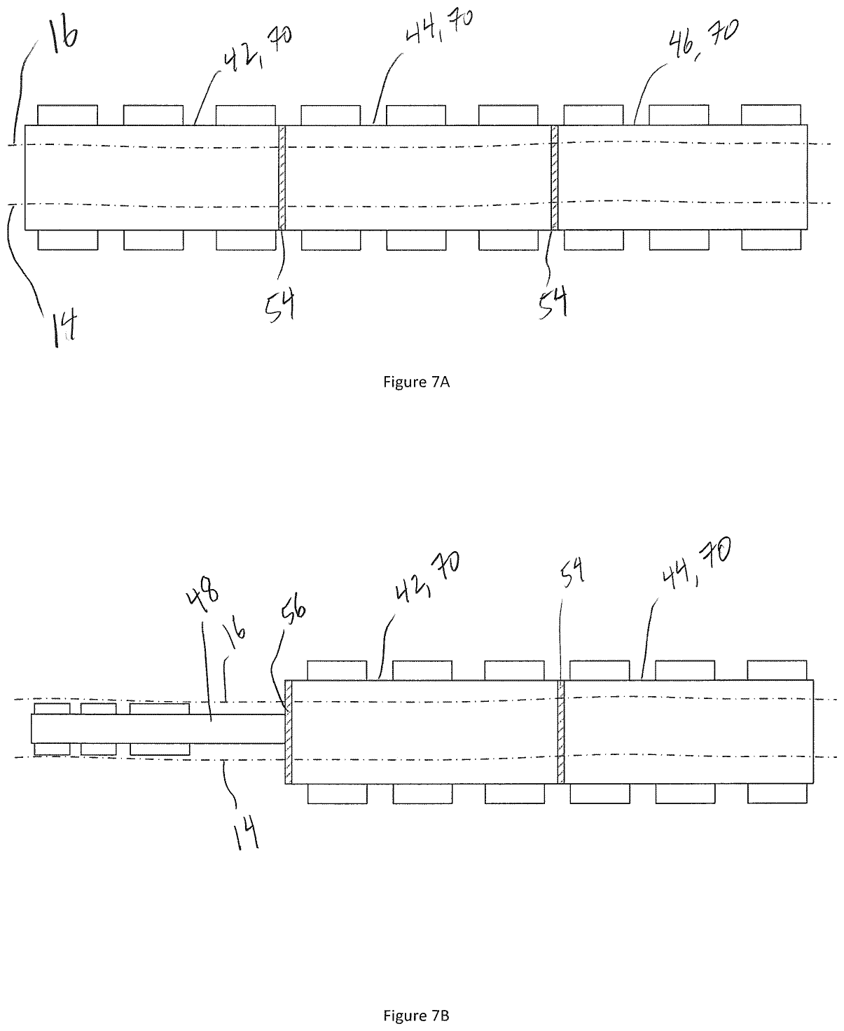

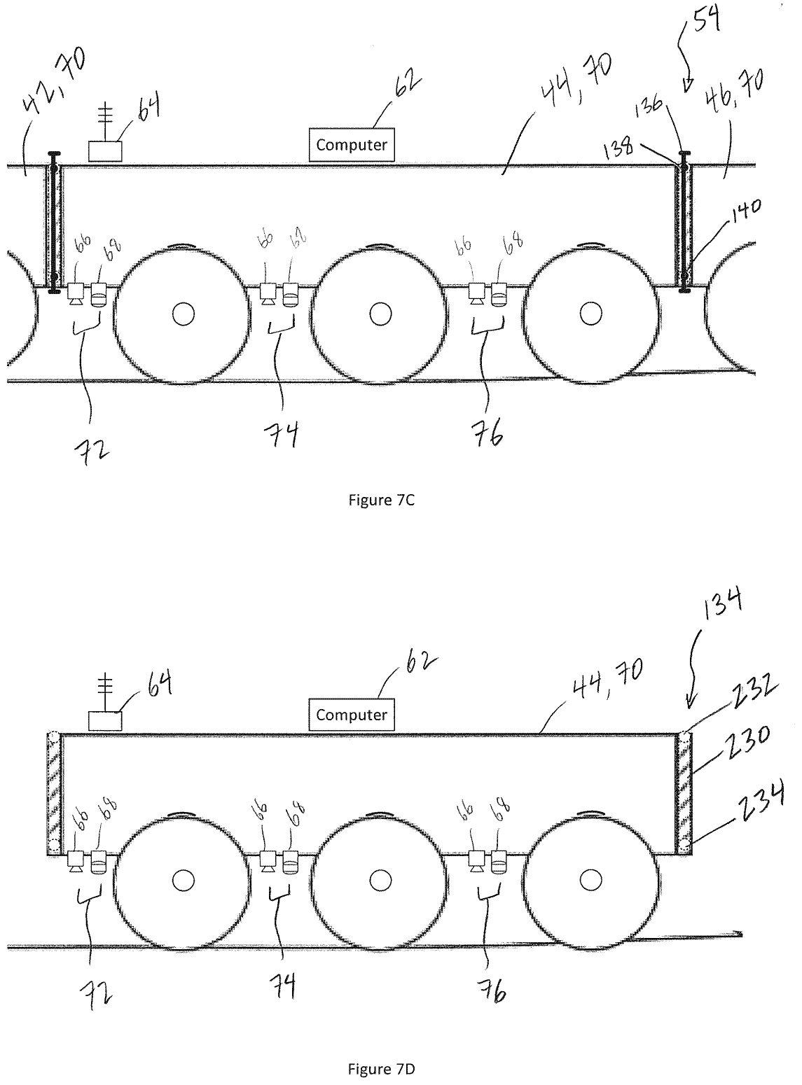

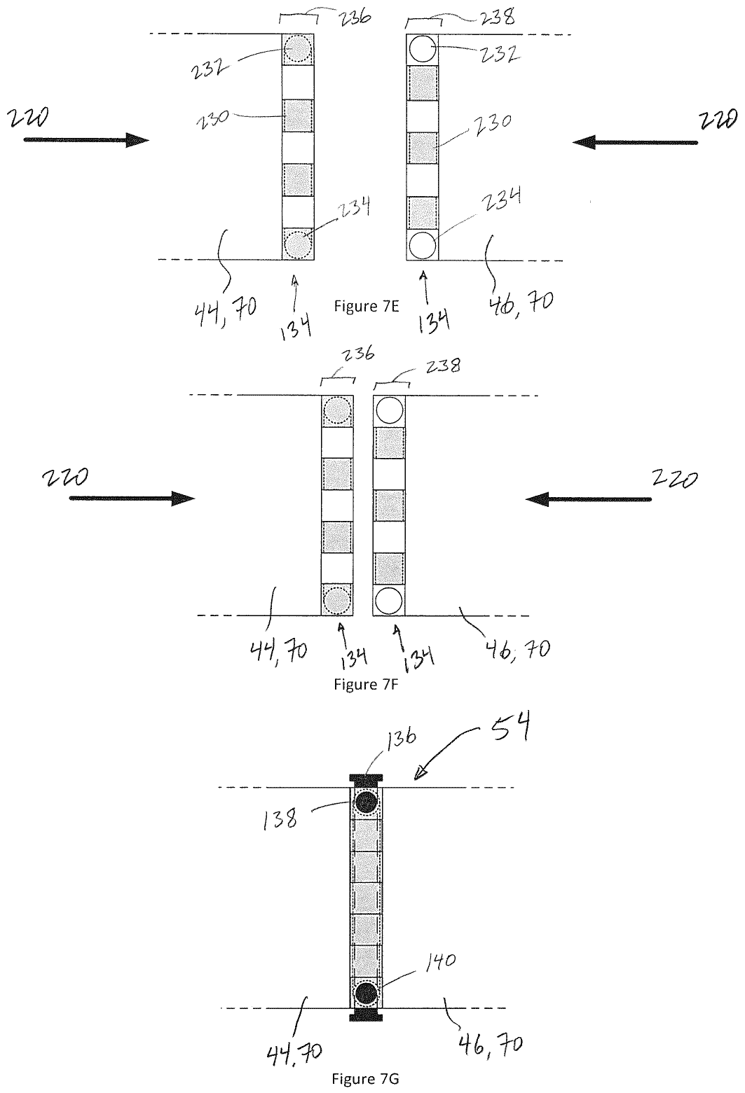

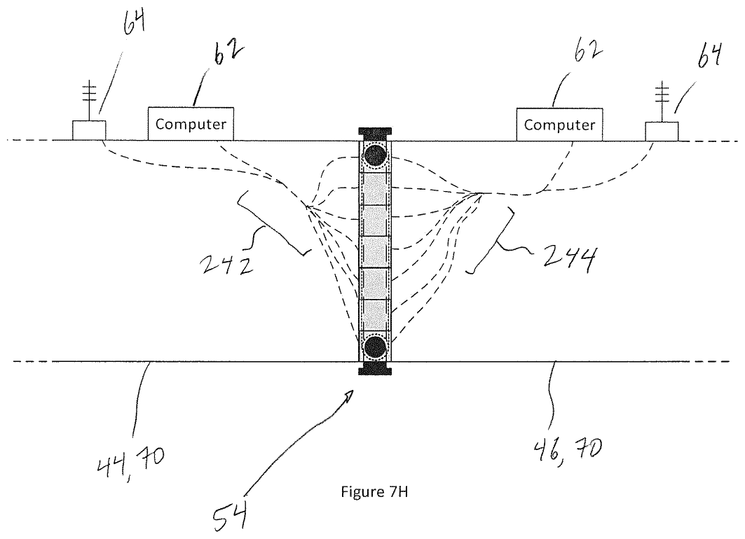

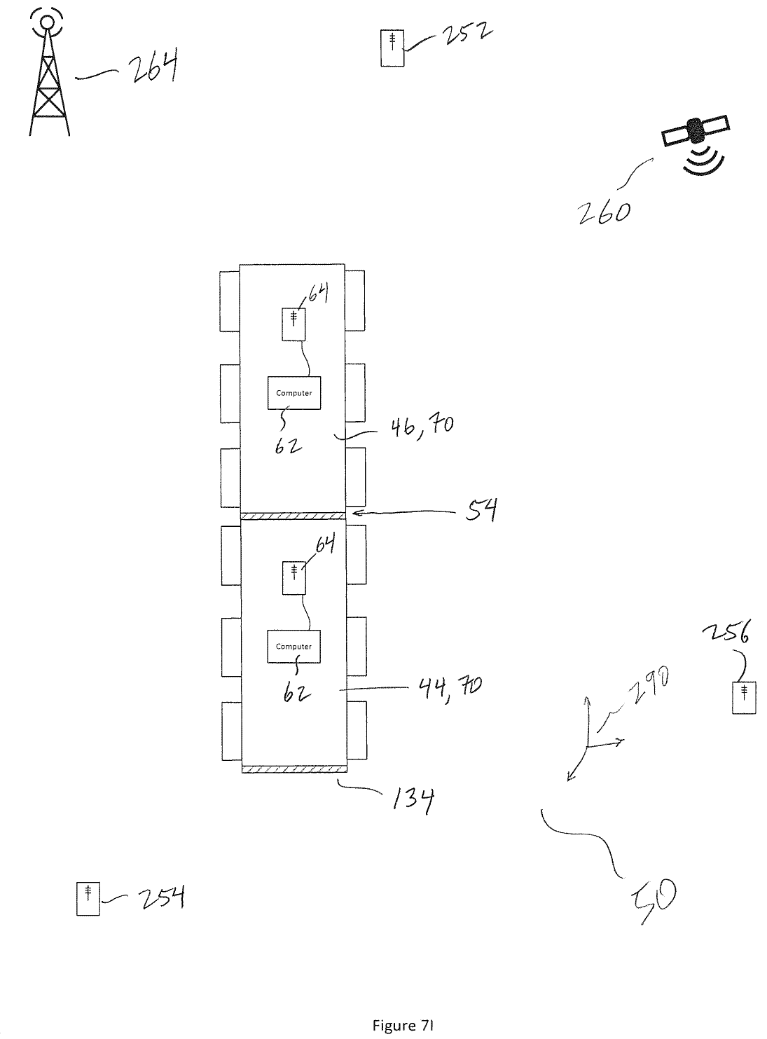

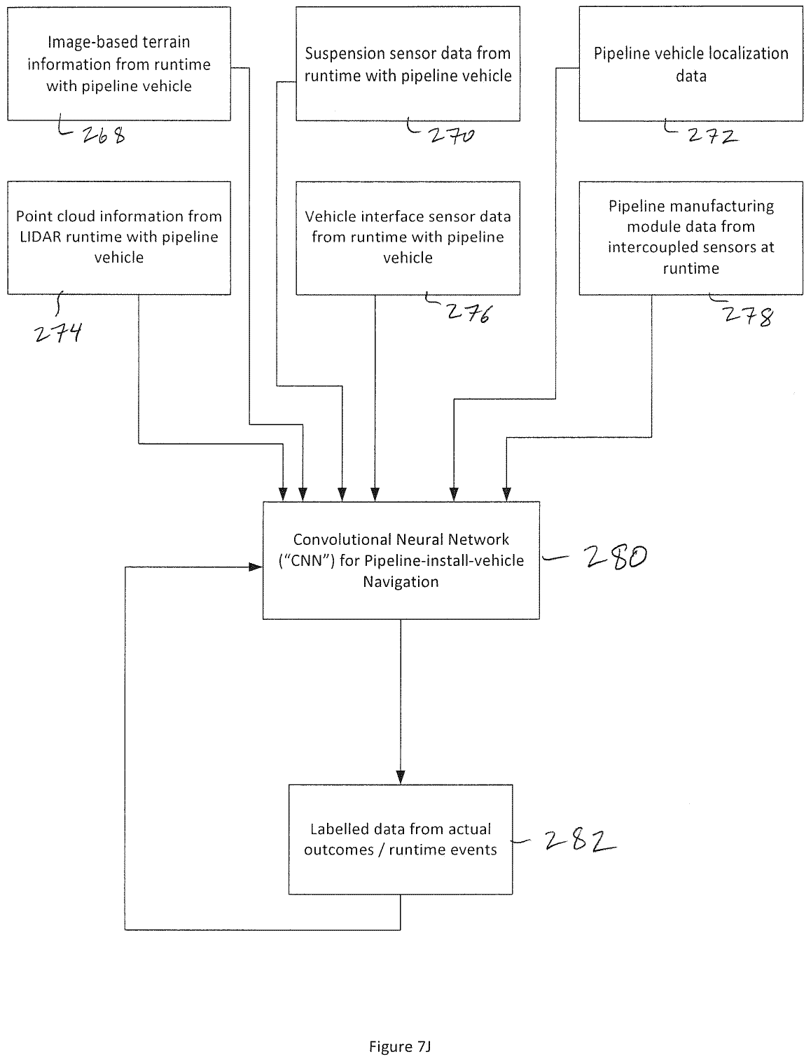

Referring to FIGS. 7A-7J, in various mobile pipeline manufacturing configurations, it may be important to coordinate positioning, orientation, and coupling of various vehicles (70, 48) such that a pipeline factory is essentially moved along the terrain in a coordinated fashion to produce long lengths of pipeline in-situ.

FIG. 7A illustrates a group of three (42, 44, 46) vehicles (70) removably coupled (54) in an end-to-end configuration and positioned and oriented to straddle a trench below defined by two trench abutments (14, 16). FIG. 7B illustrates a group of two (42, 44) vehicles (70) removably coupled (54) together, with the last vehicle (42, 70) removably coupled (56) to a trailer assembly (48) configured to have a width to fit and be pulled along the base of the trench (i.e., between the trench abutments 14, 16). Referring to FIGS. 7C-7H, removable coupling between vehicles (54) or trailer assemblies (56) may be accomplished by positioning and orienting adjacent coupling interfaces to have a desired contact configuration, and then temporarily or removably coupling or locking such contact configuration into place. For example, in various embodiments, two coupling interfaces may be removably coupled with one or more coupling pins in a manner somewhat akin to the manner wherein a door hinge pin may be utilized to couple two portions of a door hinge relative to each other. FIG. 7D illustrates an uncoupled vehicle (70) wherein each end comprises an uncoupled (134) coupling interface featuring a plurality of coupling features (230, 232, 234), such as channels configured to accommodate coupling pins, which preferably are in positions and orientations selected to provide robust coupling between vehicles when engaged in a coupled (54, 56) fashion, such as is shown in FIG. 7C, wherein three pins (136, 138, 140) have been inserted into the coupling features (230, 232, 234) to constrain one (44) vehicle (70) relative to another (46) vehicle (70).

Referring to the close-up views of FIGS. 7E-7G, when two coupling interfaces (236, 238) of adjacent vehicles (44, 46) are positioned toward (220) each other in orientations suitable to provide engagement of the coupling interfaces (236, 238), various sub-features of the coupling interfaces (236, 238) may be configured to fit together in an overlapping fashion, as shown in FIG. 7G, such that the pins (136, 138, 140) may be inserted through the coupling features (230, 232, 234), such as through-channels which are formed by aggregation of interfaced aspects of the two assemblies (236, 238).

Referring to FIG. 7H, a coupled interface (54), or uncoupled variations thereof (134), may be monitored via a plurality of contact or load sensors, such as strain gauges, light path sensors, piezoelectric load and/or contact sensors, or the like, which may be operatively coupled (such as via wired or wireless connectivity 242, 244, to the associated computing system 62 and/or wireless transceiver) to assist in monitoring and operation of a coupled assembly, as well as controlled dis-assembly. In other embodiments, removable coupling may be conducted or assisted via electromagnets, electronically-operable mechanical latches, and the like as opposed to, or in addition to, pin type configurations such as those described above.

Referring to FIG. 7I, two (44, 46) vehicles (70) are illustrated removably coupled (54) together on a ground surface (50) in a global coordinate system (290). The position and orientation of each vehicle relative to each other vehicle, and each relative to the global coordinate system (290) may be tracked using various technologies such as joint position sensors, such as joint encoders (such as those common to the robotics industry, such as those manufactured by suppliers such as Heidenhain or AMO), which may be fitted within each wheel or joint assembly, such that each movement about each axis may be precision tracked at the pertinent computing system (62). Wireless technologies may also be utilized to track the position and/or orientation of each vehicle (44, 46). For example, signal transmission analysis, such as time-of-flight, signal strength, and/or signal content analysis, may be utilized between locally-coupled transceivers (64) and remote transceivers, such as GPS transceivers (260), wireless telecom transceivers (264), and/or relatively low-power transceivers (252, 254, 256) such as IEEE 802.11 or Bluetooth devices. With each associated vehicle (44, 46) having a determination of position and orientation relative to a global coordinate system, the vehicles may be moved and oriented in a coordinated fashion, such as to move in a given direction along a trench with a preferred surface orientation relative to the ground without “fighting” against each other in terms of propulsion or navigation in a manner which may also increase interfacial loads at coupling points beyond desired ranges. In other words, the two vehicles (44, 46) may be configured and operated to move together in unison, and this capability may be utilized to operate an intercoupled pipeline manufacturing subsystem, as is further described below.

Referring to FIG. 7J, in various embodiments, so-called “artificial intelligence” may be utilized to assist in operation of a complex intercoupling of operational subsystems to facilitate a successfully evolving mobile pipeline system. A convolutional neural network (or “CNN” 280) may be developed, maintained, and improved, using significant amounts of data from data sources (268, 270, 272, 274, 276, 278) labelled during runtime and actual outcomes/runtime events (282). In other words, with a vast library and audit trail of outcomes in view of known inputs, correlations may be developed to facilitate continued improvement of the navigation CNN for better vehicle movement and associated pipeline module operation, and various levels of automation or semi-automation related thereto.

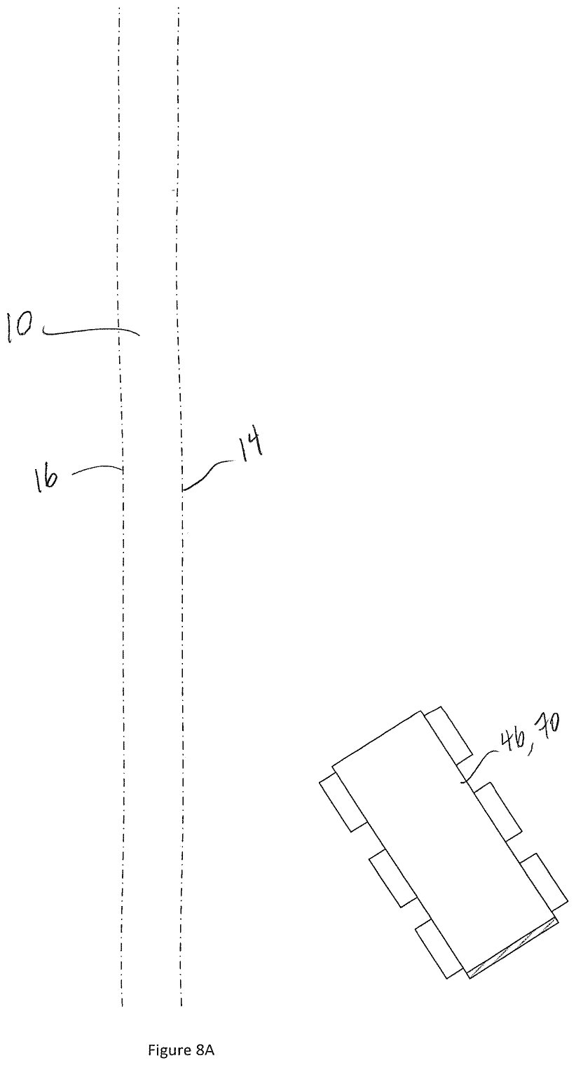

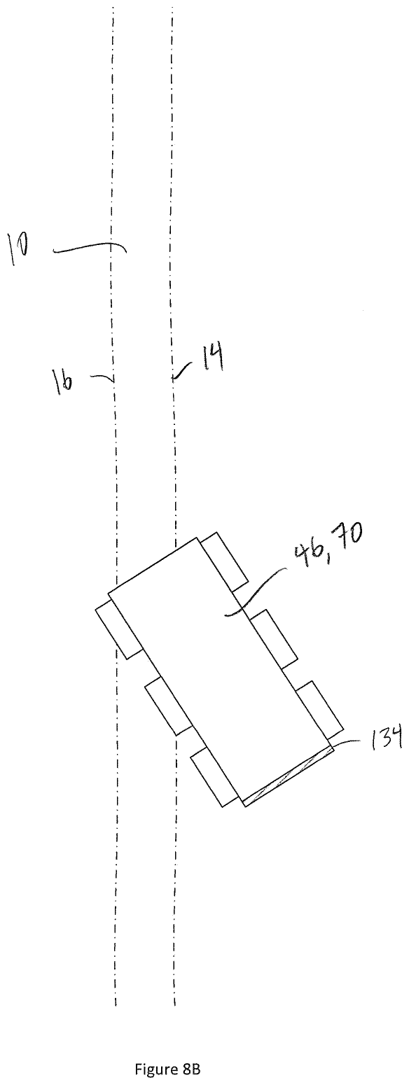

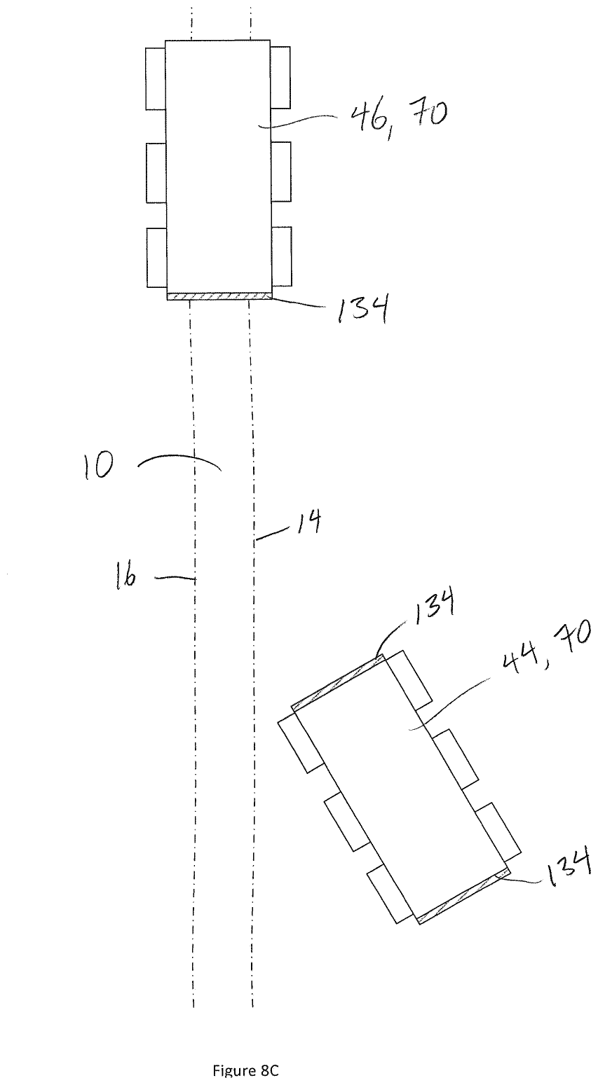

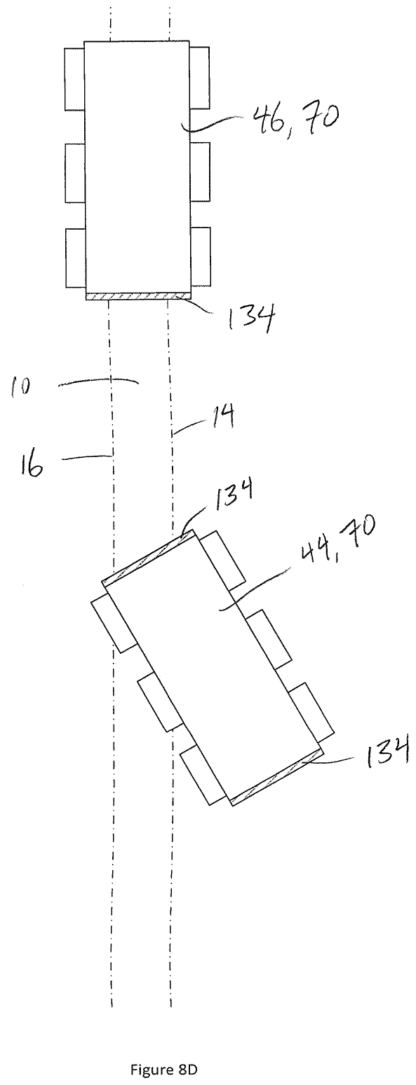

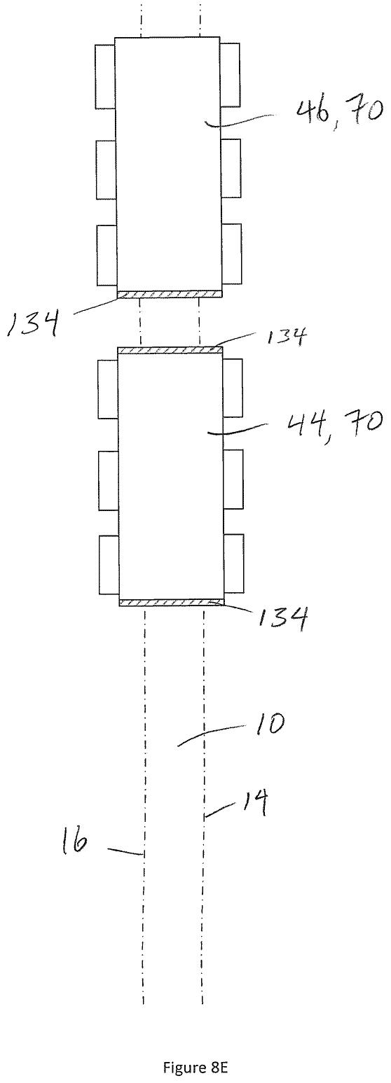

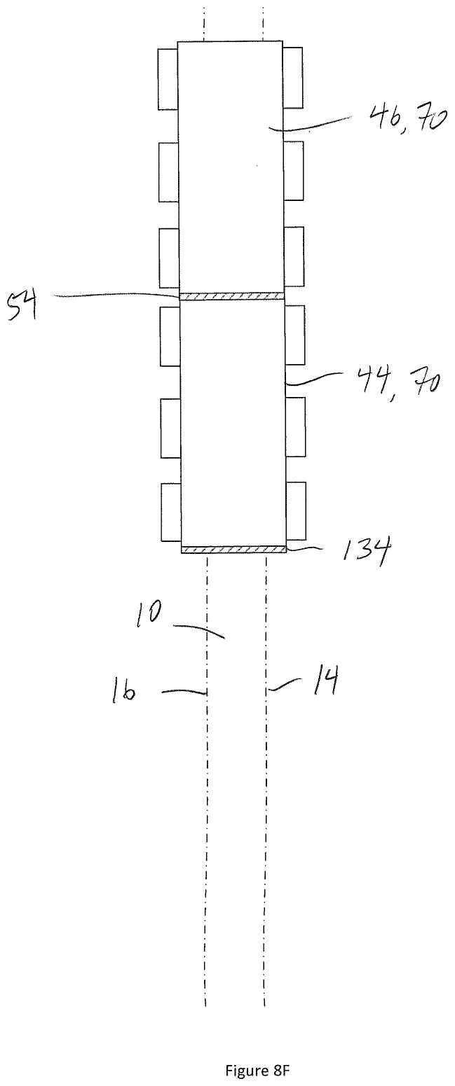

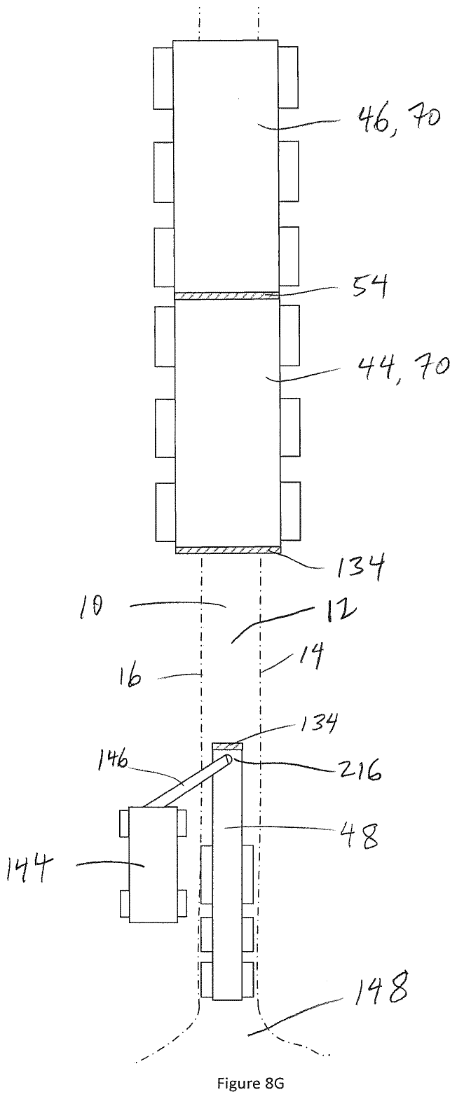

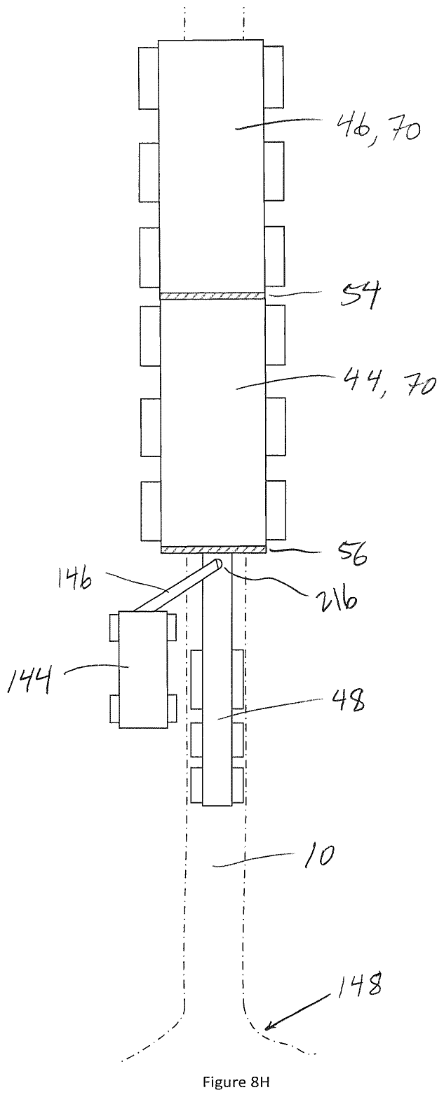

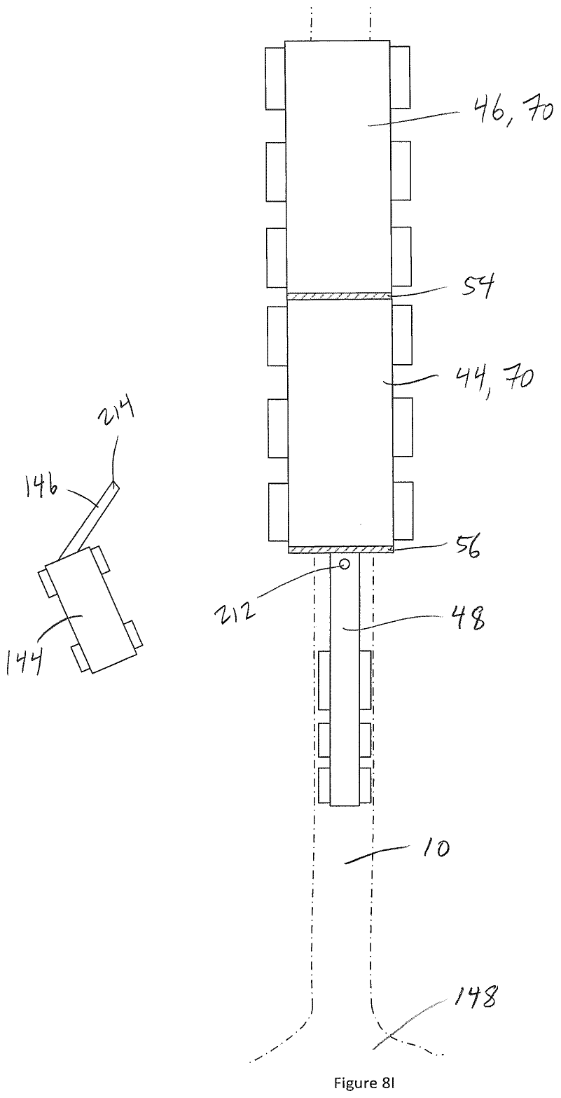

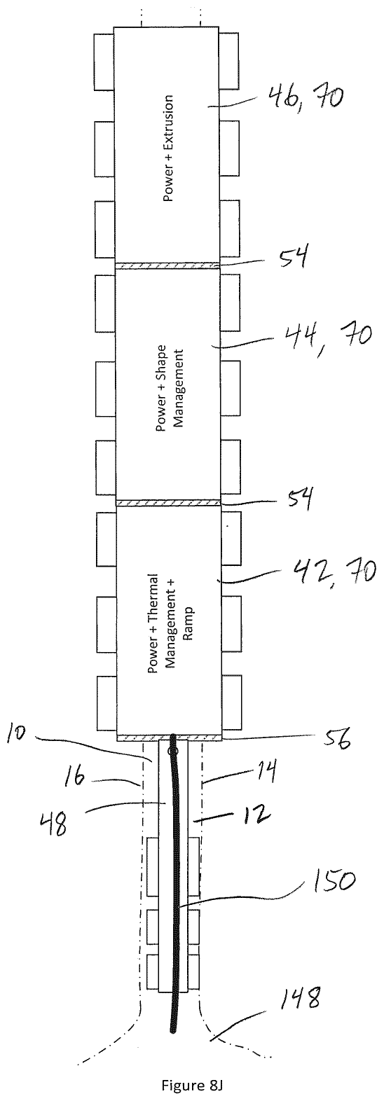

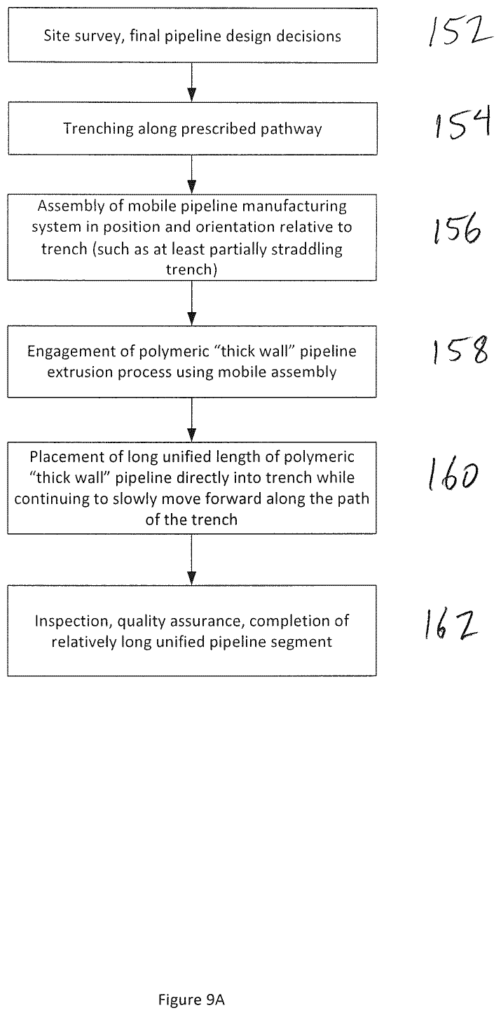

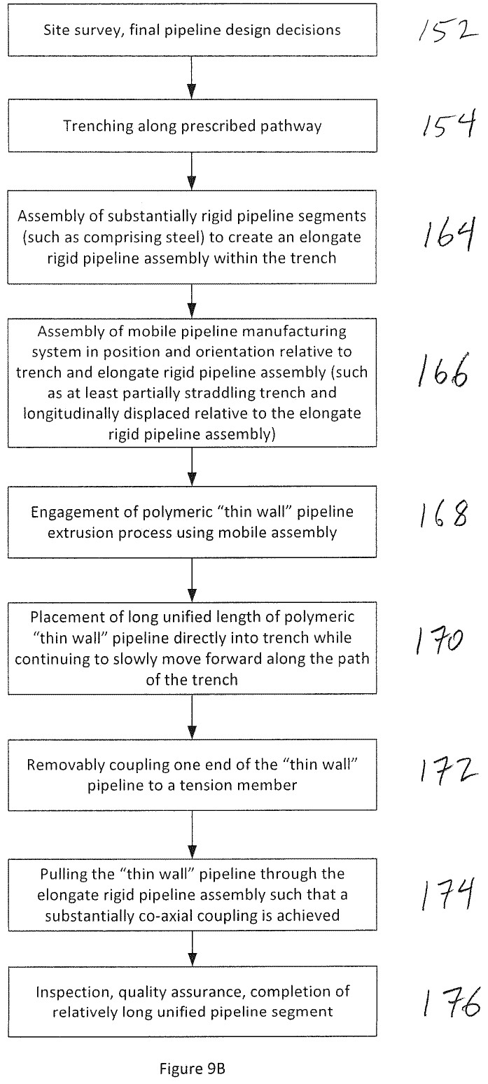

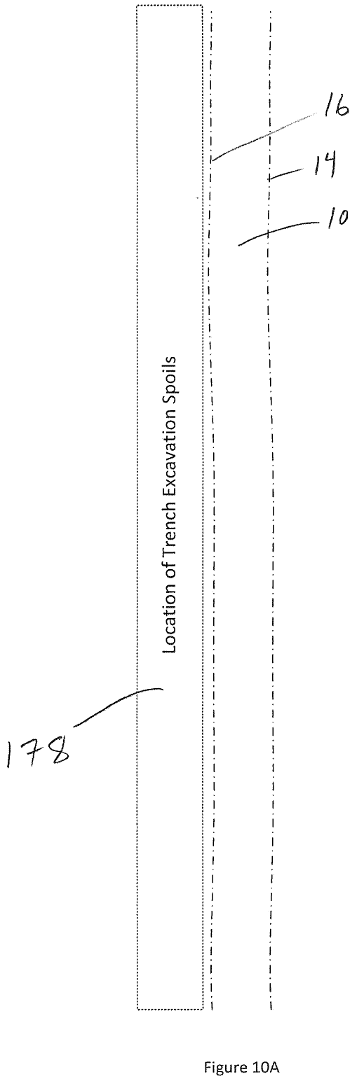

Referring to FIGS. 8A-8J, and 9A-9B, various aspects of a mobile pipeline manufacturing configurations are illustrated in reference to paradigms wherein a trench is straddled, and manufactured pipeline is deposited straight into said trench.

Referring to FIG. 8A, a trench (10) is illustrated, bounded on each side by a trench abutment (first side 14, second side 16). A first (46) vehicle (70), such as those described above, is shown navigating toward the trench (10). Referring to FIG. 8B, the six-wheeled vehicle is shown navigating over the trench (10) under propulsion as described above in reference to FIGS. 6D and 6E, for example. Referring to FIGS. 8C and 8D, with the first (46) vehicle (70) in a starting position, a second (44) vehicle (70) may be similarly navigated into position.

Referring to FIGS. 8E and 8F, the first (46) and second (44) vehicles (70) may be removably coupled, as described, for example, in reference to FIGS. 7C-7H.

Referring to FIG. 8G, with the first (46) and second (44) vehicles (70) removably coupled, a trailer (48) assembly may be brought through a low point (148) in the relative elevation between the trench base (12) and the trench abutments (14, 16), such as an origin of the trench through use of a placement vehicle (144) which may comprise a car, tractor, all-terrain vehicle, robot, or other powered vehicle configured to have an elongate and substantially rigid coupling member (146) removably coupleable to the trailer (48) with a coupling hitch or latch (216), such that the trailer (48) assembly may be driven into position toward the second (44) vehicle (70) and removably coupled (56) to the second (44) vehicle (70) as shown in FIGS. 8H and 8I, while the placement vehicle (144) may be navigated away with the distal end (214) of the elongate coupling member (146) freed from the trailer (48) assembly (the new coupling of the trailer module 48 to vehicle 44 is shown as element 212). With such a configuration, an assembly may be created which may be utilized to navigate along a trench (10), and provide a stable platform for manufacturing a pipeline. In one embodiment, each vehicle or trailer assembly may be configured to fit in a shipping container for transportation to locations all over the world.

Referring to FIG. 8J, in one embodiment, a first (46) vehicle (70) may be configured to function as a power generation vehicle as well as a material hopper and melting/processing subsystem to feed into an extrusion die, such that substantially cylindrically-cross-sectioned polymer pipe may be extruded and fed rearward into a second (44) vehicle (70), which may be configured to also function as a power reservoir (for example, each removably coupleable vehicle may comprise a power reservoir capability, such as a motor, generator, and/or battery pack, to facilitate propulsion, navigation, and/or operation of each such vehicle as well as to provision power to components coupled thereto on the same or other vehicles), while also being configured to conduct cylindrical rolling, shape management, and controlled thermal cooling (such as via monitoring using thermocouples and/or infrared monitoring) of the extruded pipe that comes to the second (44) vehicle (70) from the extrusion subsystem aboard the first (46) vehicle (70). Referring again to FIG. 8J, extruded pipe that has been shape and thermally managed by the second (44) vehicle (70) may be passed to a third (42) vehicle (70), which may be configured to also provide a power reservoir as well as further thermal management, such as via thermocouples and/or infrared monitoring of extruded pipeline portions passing across and through this vehicle (70). Referring again to FIG. 8J, extruded pipe (150) may continue to be processed through the movable vehicle assembly by passing across the end of the third (42) vehicle (70) and onto the trailer (48) assembly for moving down the sloped ramp geometry of the trailer (48) and ultimately reaching the base (12) of the trench (10), for an in-situ pipeline installment configuration.

Referring to FIGS. 9A-12B, reference is made to “thick wall” and “thin wall” pipeline scenarios. “Thick wall” is a term utilized in the pipeline industry in reference to extruded pipeline segments typically comprising a relatively large wall thickness, which typically comprise a single layer monolith (i.e., each segment may comprise a single extrusion of a polymer or polymer mix) when installed. “Thin wall” is a term utilized in the pipeline industry in reference to extruded pipeline layers which may be introduced and coupled co-axially within other, typically more rigid, outer pipeline structures, such as steel pipeline segments. With a “thin wall” pipeline configuration, typically one or more segments of the outer pipeline structure are placed upon a ground surface at or near a final pipeline installation location, and a thin, typically polymeric, pipeline structure is pulled through the outer pipeline structure to a coupling position, such that the combination of the outer pipeline structure and inner liner structure provide a co-axial composite whereby rigidity and kink resistance are enhanced by the typically-more-rigid outer pipeline structure, while the inner liner structure provides a desirably relatively-smooth and relatively less-corrosive inner surface to define a working lumen through which pipeline contents (such as water, wastewater, gasses, petroleum-related fluids, etc) are to flow.

Referring to FIG. 9A, a pipeline installation process configuration is illustrated, wherein a site survey may be conducted and final pipeline design decisions made pertaining to selected installation location (152). Trenching may be conducted along a prescribed pathway, such as with a trenching machine (154). A mobile pipeline creation system may be assembled in position and orientation relative to trench (such as at least partially straddling trench) (156). The assembly may be utilized to engage in a polymeric “thick wall” pipeline extrusion process using the mobile assembly, such that polymeric pipeline ingredients flow from a hardened form in a hopper, into a heating process, and through an extrusion die to create a substantially thick-walled and cylindrical cross-sectioned pipeline extrusion designed to be placed in a trench or other installation and utilized without further coaxial layering

installation (158). Utilizing such an assembly, a relatively long, unified length of polymeric “thick wall” pipeline may be placed directly into a trench while the assembly continues to move forward along the path of the trench (160). Inspection and/or quality assurance steps may follow to complete manufacture and placement of a relatively long monolithic pipeline segment (162). For example, the subject mobile extrusion system may be configured to have sensors such as thermocouples, humidity detectors, geometric detectors, and the like to monitor output variables such as output extrusion thickness, ovality (i.e., circularity), elongate straightness, ambient temperature (which may pertain to local material modulus of elasticity, or bulk or structural modulus) so that appropriate accommodations may be made (for example, with additional humidity, it may be appropriate to increase extrusion temperatures).

Referring to FIG. 9B, another pipeline installation process configuration is illustrated, wherein so-called “thin wall” elongate unified pipeline lengths may be created in-situ with the intention to pull such lengths into co-axial positions within other conduits, such as steel conduits, to provide a polymeric “thin wall” lining for such conduits. A site survey may be conducted and final pipeline design decisions made pertaining to selected installation location (152). Trenching may be conducted along a prescribed pathway, such as with a trenching machine (154). Substantially rigid pipeline segments (such as comprising steel) may be assembled to create an elongate rigid pipeline assembly within the trench, with the intention that such assembly be lined with a polymeric “thin-wall” lining configuration (164). A mobile pipeline creation system may be assembled in position and orientation relative to the trench and elongate rigid pipeline assembly (for example, in a configuration wherein the pipeline manufacturing assembly is at least partially straddling the trench and is longitudinally displaced relative to the elongate rigid pipeline assembly) (166). A polymeric “thin-wall” pipeline extrusion process may be engaged with the mobile manufacturing assembly to extrude relatively long lengths of polymeric pipeline sized to be placed as a lining to the elongate rigid pipeline assembly (168). A long, unified length of polymeric thin-wall pipeline may be placed directly into the trench while the mobile manufacturing assembly continues to slowly move forward along the path of the trench (170). One end of a completed thin-wall polymeric pipeline may be removably coupled to a tension member, such as a tension cable (172) and the thin-wall pipeline may be pulled through at least a portion of the elongate rigid pipeline assembly, such that a substantially co-axial coupling is achieved (for example, with a unified elongate polymeric lining coupled through a significant number of intercoupled rigid pipeline segments) (174). Inspection and/or quality assurance steps may follow to complete manufacture and placement of a relatively long monolithic pipeline segment (176).

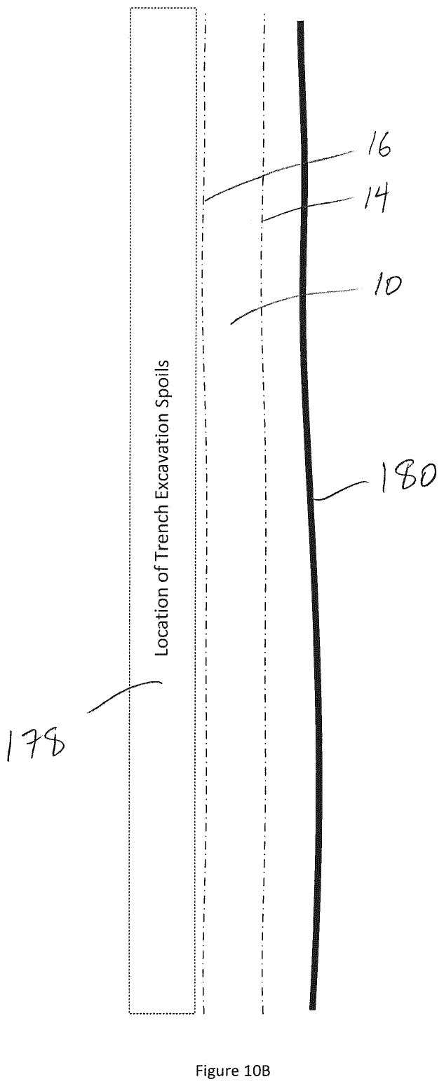

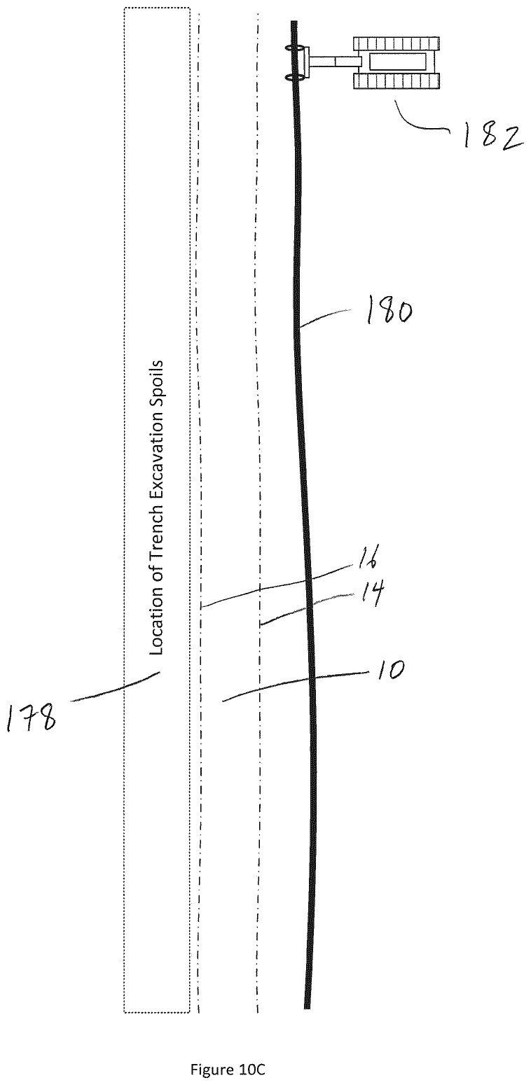

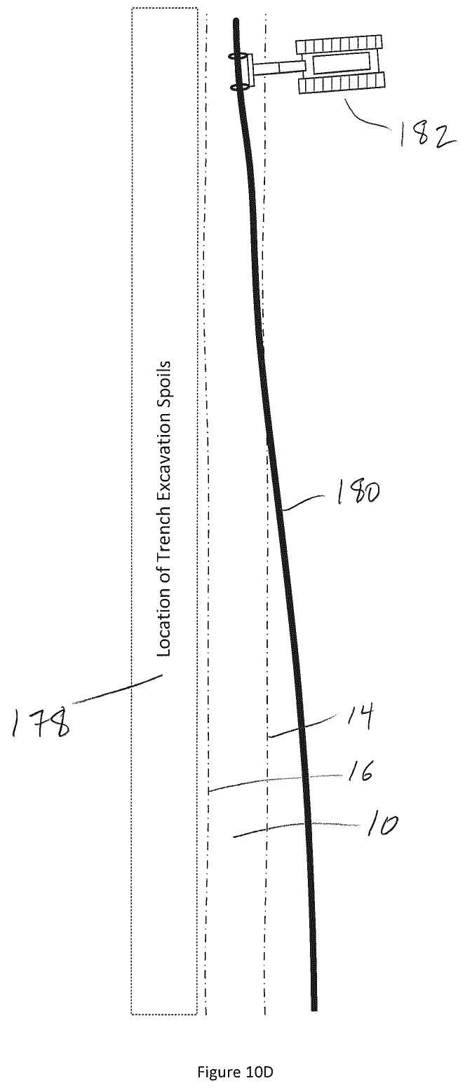

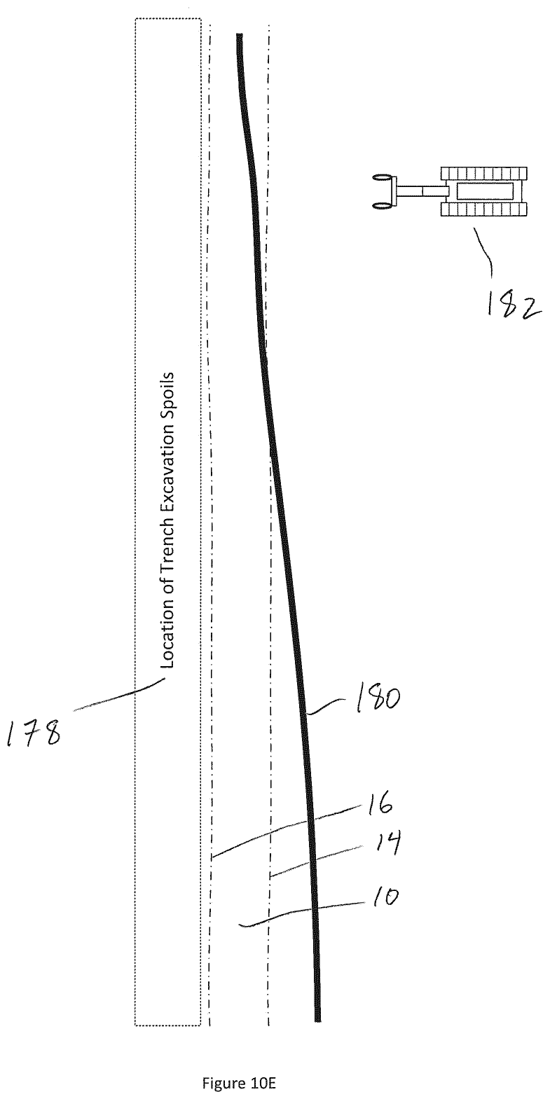

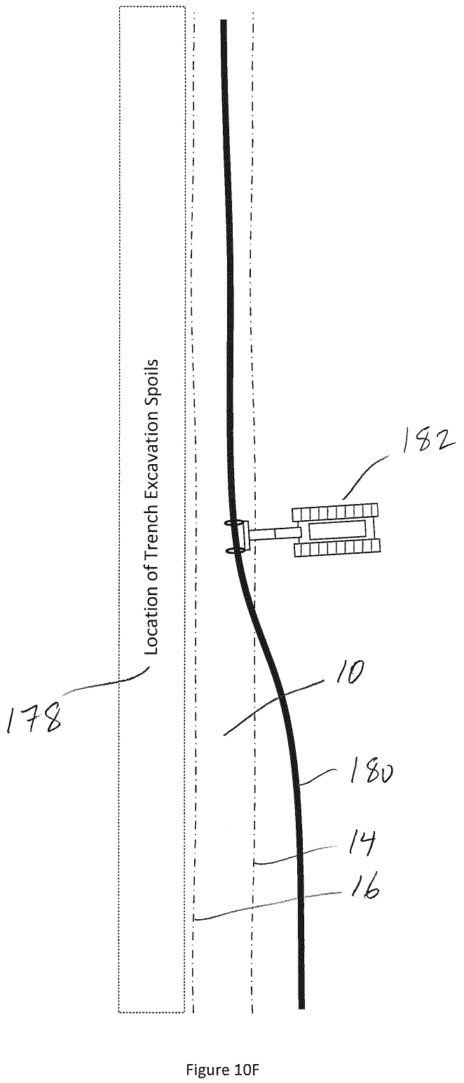

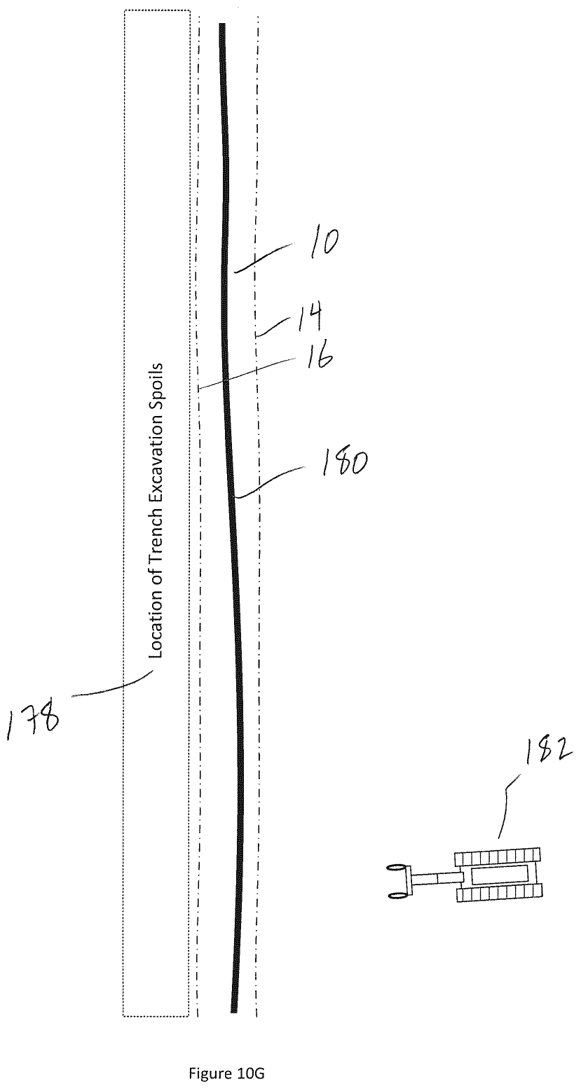

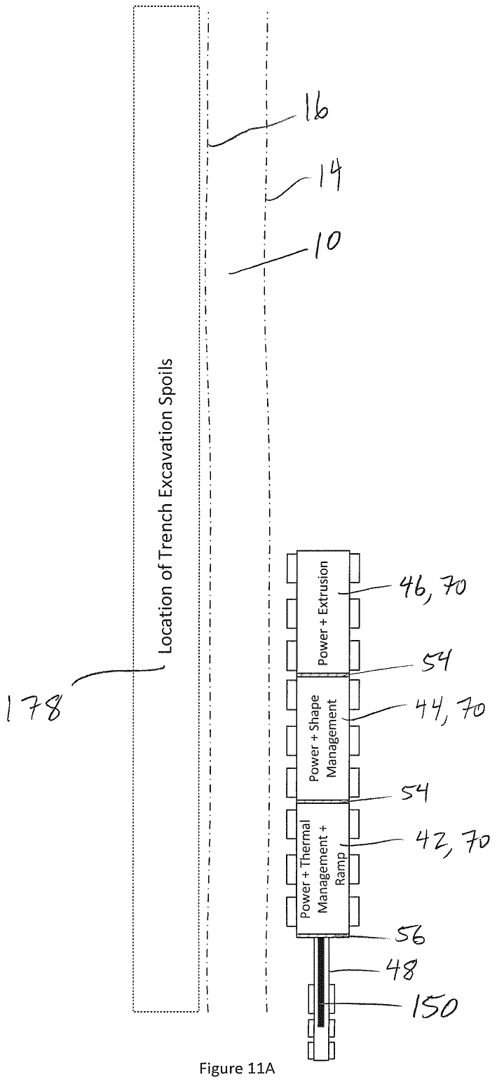

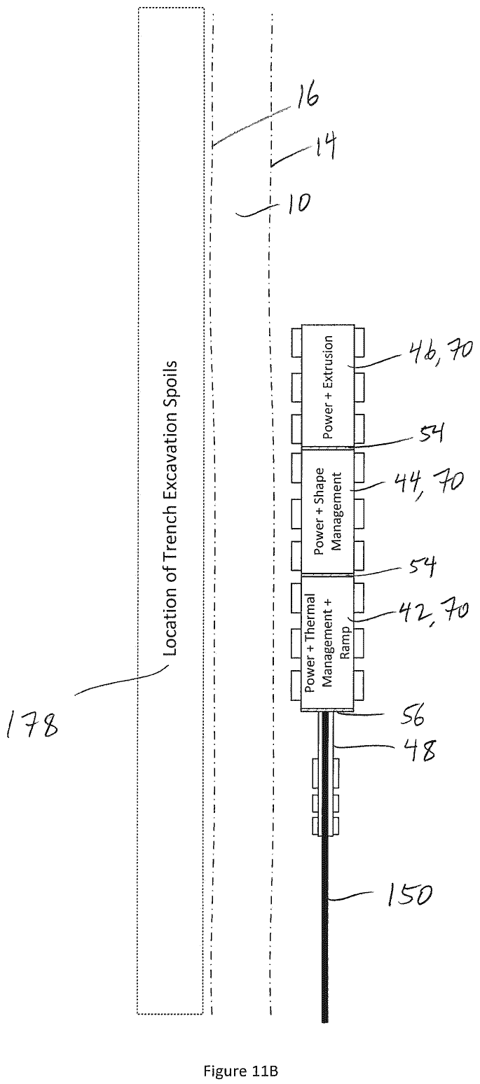

Referring to FIGS. 10A-10G, 11A-11D, and 12A-12B, various aspects of a mobile pipeline manufacturing configurations are illustrated in reference to paradigms wherein manufactured pipeline is deposited upon an abutment adjacent a trench, and then may be subsequently moved into said trench for final placement.

Referring to FIG. 10A, a trench (10) is shown, defined in part by first (14) and second (16) trench abutments. Trench excavation spoils (178) are shown located on at least part of the second trench abutment (16). Referring to FIG. 10B, a pipeline (180) has been assembled upon the first trench abutment (14), wherein it may, for example, be convenient to conduct certain assembly steps (i.e., relative to within the depths of a trench). As shown in FIGS. 10C-10G, a pipeline handing vehicle (182), such as one based upon a bulldozer or front-end-loading machine, may be utilized to incrementally position the pipeline (180) into the trench (10).

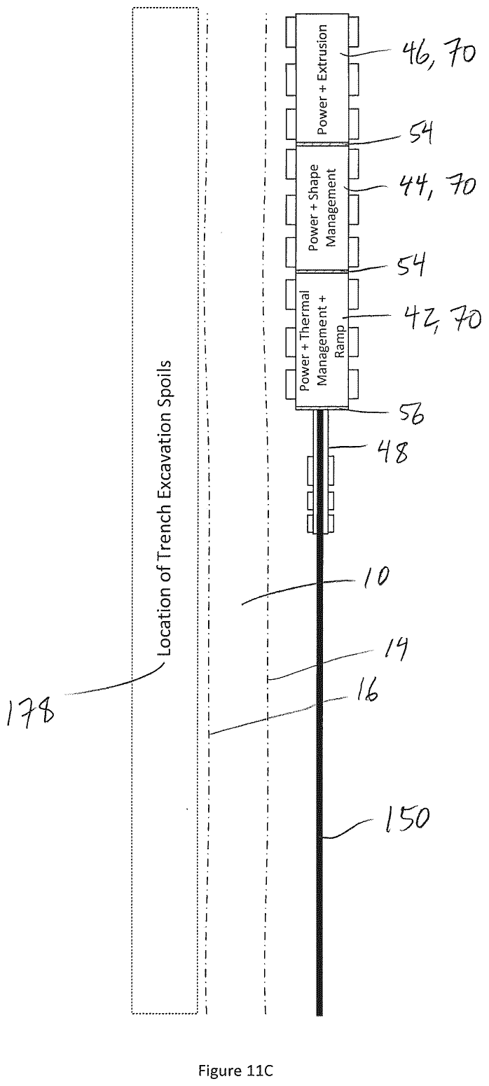

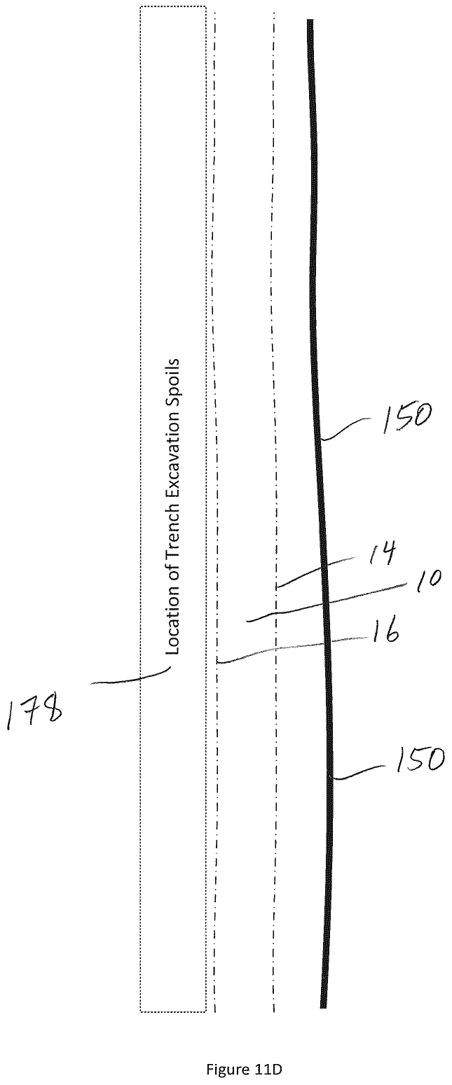

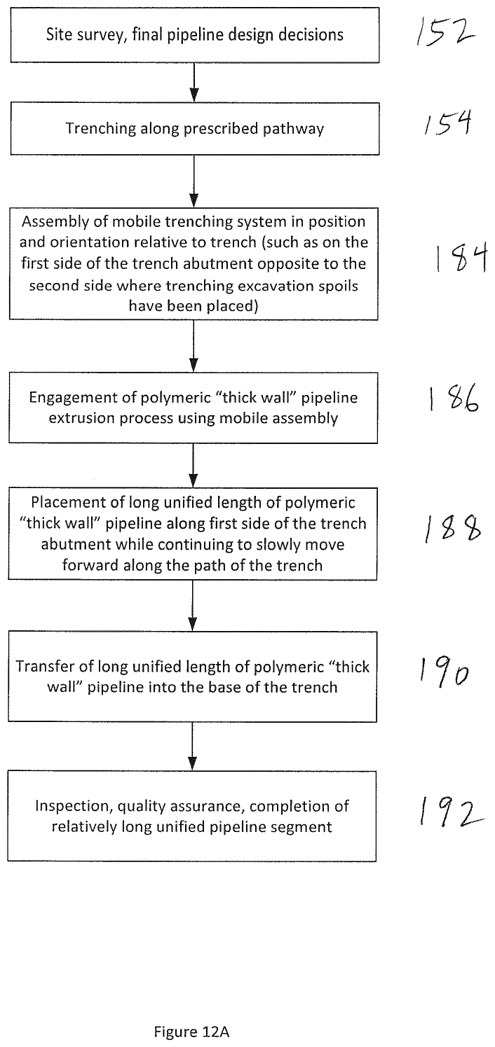

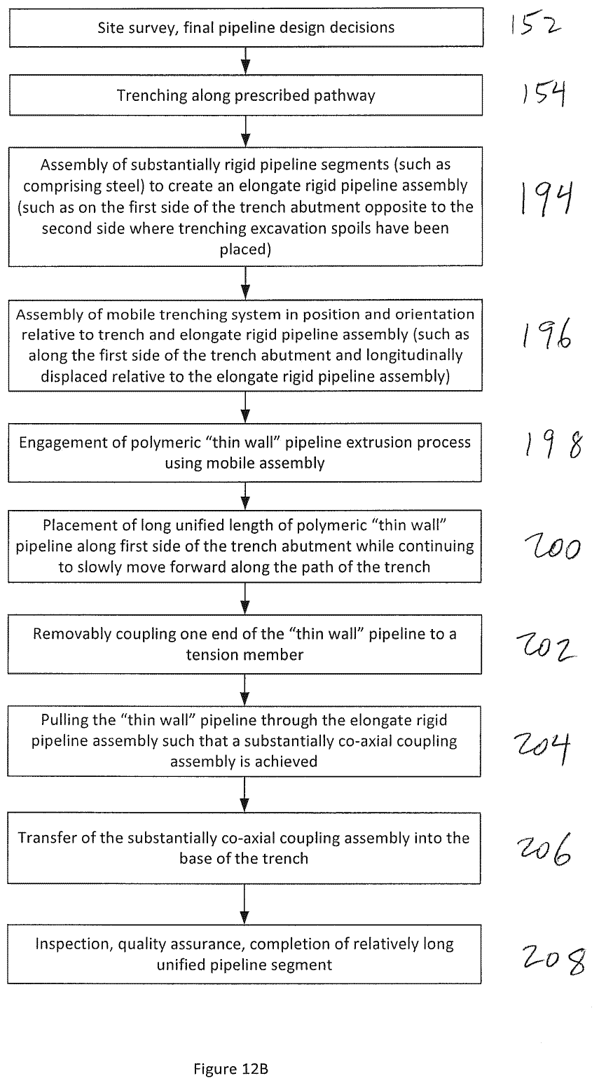

Referring to FIGS. 11A-11D, a modular and mobile pipeline manufacturing system similar to that described, for example, in reference to FIG. 8J, may be utilized to manufacture and place on one of the trench abutments, such as the first trench abutment (14) opposite the second trench abutment (16) with the excavation spoils (178), an elongate and unified pipeline or segment thereof (150). With the relatively long, unified pipeline or segment thereof in position upon the trench abutment (14) as shown in FIG. 11D, with a thick-wall type of pipeline extrusion, such pipeline or segment thereof may be placed directly into the trench (10) as in a process such as that described in reference to FIGS. 10A-10G; such a process is illustrated in FIG. 12A. With the relatively long, unified pipeline or segment thereof in position upon the trench abutment (14) as shown in FIG. 11D, with a thin-wall type of pipeline extrusion, such pipeline or segment thereof may be positioned coaxially inside of a substantially rigid pipeline construct, such as one made from steel segments, still on the trench abutment wherein access may be relatively uncomplicated (i.e., relative to within the depths of the trench), and then the coaxially-coupled assembly may be moved into the trench in a process such as that described in reference to FIGS. 10A-10G; such a process is illustrated in FIG. 12B.

Thus referring to FIG. 12A, a site survey may be conducted and final pipeline design decisions made pertaining to selected installation location (152). Trenching may be conducted along a prescribed pathway, such as with a trenching machine (154). A mobile trenching system may be assembled in position and orientation relative to trench (such as on the first side of the trench abutment opposite to the second side where trenching excavation spoils have been placed) (184). A polymeric “thick wall” pipeline extrusion process may be engaged using the mobile assembly (186), to create and place an elongate pipeline or segment thereof in a location such as upon a trench abutment, while continuing to slowly move forward along the path of the trench (188). The long unified length of polymeric thick-wall pipeline may be transferred into the base of the trench, such as via a pipeline handling vehicle (190). Inspection and/or quality assurance steps may follow to complete manufacture and placement of a relatively long unified pipeline segment (192).

Referring to FIG. 12B, a site survey may be conducted and final pipeline design decisions made pertaining to selected installation location (152). Trenching may be conducted along a prescribed pathway, such as with a trenching machine (154). A group of substantially rigid pipeline segments (such as comprising steel) may be assembled or coupled to create an elongate rigid pipeline assembly (such as on the first side of the trench abutment opposite to the second side where trenching excavation spoils have been placed) (194). A mobile trenching system may be assembled in position and orientation relative to trench and elongate rigid pipeline assembly (such as along the first side of the trench abutment and longitudinally displaced relative to the elongate rigid pipeline assembly) (196). A polymeric “thin wall” pipeline extrusion process may be engaged using mobile assembly (198). A long unified length of polymeric “thin wall” pipeline may be manufactured and placed along first side of the trench abutment using the mobile assembly while it continues to slowly move forward along the path of the trench (200). One end of the “thin wall” pipeline may be removably coupled to a tension member, such as a tension cable (202) and the “thin wall” pipeline or segment thereof may be pulled through the elongate rigid pipeline assembly, such that a substantially co-axial coupling assembly is achieved (204). The substantially co-axial coupling assembly may be transferred into the base of the trench (206), in a manner akin to that described above in reference to FIGS. 10A-10G. Inspection and/or quality assurance steps may follow to complete manufacture and placement of a relatively long unified pipeline segment (208).

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A mobile pipeline extrusion system, comprising:
a. a first mobile vehicle having a first electromechanical drive system and a first active suspension configured to stabilize the first mobile vehicle relative to terrain over which it may be navigated;
b. a second mobile vehicle removably coupleable to the first mobile vehicle and having a second electromechanical drive system and a second active suspension configured to stabilize the second mobile vehicle relative to terrain over which it may be navigated;
c. a computing system operably coupled to the first and second mobile vehicles and configured to operate the first and second electromechanical drive systems and first and second active suspensions such that the first and second mobile vehicles may move together in an end-to-end coupling configuration as a unified operational platform;
d. a polymeric pipeline extrusion system operatively coupled to the unified operational platform and configured to receive input materials, heat the input materials, process the input materials through an extrusion die, and produce an output pipeline.

2. The system of claim 1, wherein the first electromechanical drive system comprises a plurality of electric motors.

3. The system of claim 1, wherein the first electromechanical drive system comprises three or more wheels and is configured to provide two or more degrees of freedom of controllable motion at each wheel.

4. The system of claim 3, wherein the first electromechanical drive system is configured to provide controlled active wheel drive as well as active wheel steer for each of the two or more degrees of freedom of controllable motion at each wheel.

5. The system of claim 4, wherein the first electromechanical drive system degrees of freedom of controllable motion cause the first mobile vehicle to be electromechanically holonomic.

6. The system of claim 3, wherein the first mobile vehicle comprises four wheels.

7. The system of claim 3, wherein the first mobile vehicle comprises six wheels.

8. The system of claim 1, wherein the first active suspension comprises an electric motor operatively coupled to a wheel of the first mobile vehicle.

9. The system of claim 8, wherein the electric motor is configured to controllably raise or lower the wheel relative to the first mobile vehicle.

10. The system of claim 9, further comprising one or more sensors configured to characterize at least one aspect of the terrain adjacent the wheel, wherein the electric motor is configured to controllably raise or lower the wheel relative to the first mobile vehicle responsive to the at least one aspect of the terrain adjacent the wheel.

11. The system of claim 10, wherein the one or more sensors are configured to characterize the elevation of the terrain adjacent the wheel.

12. The system of claim 10, wherein the one or more sensors comprise an image capture device.

13. The system of claim 10, wherein the one or more sensors comprise a LIDAR sensor.

14. The system of claim 1, further comprising a computer operatively coupled to the first mobile vehicle and configured to operate the first electromechanical drive and first active suspension dynamic to the terrain over which the first mobile vehicle is navigated, and also dynamic to operation of the polymeric pipeline extrusion system.

15. The system of claim 14, wherein the computer operates utilizing a convolutional neural network configured to modulate operation of the first mobile vehicle dynamic to detected inputs as well as training data from previous runtime events.

16. The system of claim 14, wherein the polymeric pipeline extrusion system outputs the output pipeline at an output velocity, and wherein the computer is configured to operate the first electromechanical drive and first active suspension to have a first mobile vehicle forward drive velocity that approximately matches the output velocity.

17. The system of claim 1, wherein the first and second mobile vehicles are configured to be removably coupleable using a latch mechanism.

18. The system of claim 17, wherein the latch mechanism is manually operable.

19. The system of claim 17, wherein the latch mechanism is electromechanically operable.

20. The system of claim 17, wherein the latch mechanism comprises one or more removable locking pins.

21. The system of claim 17, wherein the latch mechanism comprises a plurality of complementary mechanical engagement features.

22. The system of claim 1, wherein the first and second mobile vehicles are configured to be removably coupleable using an electromagnet.

23. The system of claim 1, wherein the input materials are selected from the group consisting of: liquid polymeric resin, solid polymeric resin pellets, and solid polymeric resin powder.

24. The system of claim 1, further comprising a power generation system coupled to the unified operational platform.

25. The system of claim 1, further comprising a thermal management output ramp coupled to the unified operational platform.

26. The system of claim 1, further comprising an input materials supply vehicle configured to provision the input materials to the polymeric pipeline extrusion system during operation.

27. The system of claim 1, further comprising an input hopper configured to contain the input materials as they are fed into the polymeric pipeline extrusion system.

28. A mobile pipeline extrusion method, comprising:
a. providing a first mobile vehicle having a first electromechanical drive system and a first active suspension configured to stabilize the first mobile vehicle relative to terrain over which it may be navigated, a second mobile vehicle removably coupleable to the first mobile vehicle and having a second electromechanical drive system and a second active suspension configured to stabilize the second mobile vehicle relative to terrain over which it may be navigated, a computing system operably coupled to the first and second mobile vehicles and configured to operate the first and second electromechanical drive systems and first and second active suspensions such that the first and second mobile vehicles may move together in an end-to-end coupling configuration as a unified operational platform, and a polymeric pipeline extrusion system operatively coupled to the unified operational platform and configured to receive input materials, heat the input materials, process the input materials through an extrusion die, and produce an output pipeline; and
b. navigating the unified operational platform forward while outputting the output pipeline at a selectable output length.

29. The method of claim 28, wherein the first electromechanical drive system comprises a plurality of electric motors.

30. The method of claim 28, wherein the first electromechanical drive system comprises three or more wheels and is configured to provide two or more degrees of freedom of controllable motion at each wheel.

31. The method of claim 30, wherein the first electromechanical drive system is configured to provide controlled active wheel drive as well as active wheel steer for each of the two or more degrees of freedom of controllable motion at each wheel.

32. The method of claim 31, wherein the first electromechanical drive system degrees of freedom of controllable motion cause the first mobile vehicle to be electromechanically holonomic.

33. The method of claim 30, wherein the first mobile vehicle comprises four wheels.

34. The method of claim 30, wherein the first mobile vehicle comprises six wheels.

35. The method of claim 28, wherein the first active suspension comprises an electric motor operatively coupled to a wheel of the first mobile vehicle.

36. The method of claim 35, wherein the electric motor is configured to controllably raise or lower the wheel relative to the first mobile vehicle.

37. The method of claim 36, further comprising providing one or more sensors configured to characterize at least one aspect of the terrain adjacent the wheel, wherein the electric motor is configured to controllably raise or lower the wheel relative to the first mobile vehicle responsive to the at least one aspect of the terrain adjacent the wheel.

38. The method of claim 37, wherein the one or more sensors are configured to characterize the elevation of the terrain adjacent the wheel.

39. The method of claim 37, wherein the one or more sensors comprise an image capture device.

40. The method of claim 37, wherein the one or more sensors comprise a LIDAR sensor.

41. The method of claim 28, further comprising providing a computer operatively coupled to the first mobile vehicle and configured to operate the first electromechanical drive and first active suspension dynamic to the terrain over which the first mobile vehicle is navigated, and also dynamic to operation of the polymeric pipeline extrusion system.

42. The method of claim 41, wherein the computer operates utilizing a convolutional neural network configured to modulate operation of the first mobile vehicle dynamic to detected inputs as well as training data from previous runtime events.

43. The method of claim 41, wherein the polymeric pipeline extrusion system outputs the output pipeline at an output velocity, and wherein the computer is configured to operate the first electromechanical drive and first active suspension to have a first mobile vehicle forward drive velocity that approximately matches the output velocity.

44. The method of claim 28, wherein the first and second mobile vehicles are configured to be removably coupleable using a latch mechanism.

45. The method of claim 44, wherein the latch mechanism is manually operable.

46. The method of claim 44, wherein the latch mechanism is electromechanically operable.

47. The method of claim 44, wherein the latch mechanism comprises one or more removable locking pins.

48. The method of claim 44, wherein the latch mechanism comprises a plurality of complementary mechanical engagement features.

49. The method of claim 28, wherein the first and second mobile vehicles are configured to be removably coupleable using an electromagnet.

50. The method of claim 28, wherein the input materials are selected from the group consisting of: liquid polymeric resin, solid polymeric resin pellets, and solid polymeric resin powder.

51. The method of claim 28, further comprising providing a power generation system coupled to the unified operational platform.

52. The method of claim 28, further comprising providing a thermal management output ramp coupled to the unified operational platform.

53. The method of claim 28, further comprising providing an input materials supply vehicle configured to provision the input materials to the polymeric pipeline extrusion system during operation.

54. The method of claim 28, further comprising providing an input hopper configured to contain the input materials as they are fed into the polymeric pipeline extrusion system.
